(19) United States
(12) Patent Application Publication
(10) Pub. No.: US 2022/0343423 A1
(43) Pub. Date: Oct. 27, 2022

(54) Method of verifying loan

(71) Applicant: Nankuei Lin, Taipei (TW)

(72) Inventor: Nankuei Lin, Taipei (TW)

(21) Appl. No.: 17/809,014

(22) Filed: Jun. 27, 2022

(30) Foreign Application Priority Data
Jan. 28, 2022 (TW) 111103975

(51) Int. Cl. G06Q 40/02

(52) U.S. Cl. CPC G06Q 40/025

(57) ABSTRACT

A method of intelligently verifying loan procedure is implemented in a system of intelligently verifying loan procedure including an intelligent loan procedure platform system and an intelligent loan procedure management system. The intelligent loan procedure platform system enables a borrower to start a loan procedure and stores relevant loan documents and loan records in a proof system as proof.

### FIELD OF THE INVENTION

The invention relates to loan and more particularly to a method of intelligently verifying loan procedure.

### BACKGROUND OF THE INVENTION

In a loaning procedure, a borrower may submit a loan via an agent or a bank employee. But loan information, loan data and loan documents are not available to the borrower. It is often that an agent, an appraisal specialist or a bank employee may cheat the borrower by providing false loan data or appraisal information to the borrower. Thus, collateral may be underestimated, the borrower may be charged with very high interests, or there are cheating articles in the loan agreement. This can cause many disputes or different interpretations. Thus, it is desirable to provide a mechanism to verify document files and data records of a high priced property (e.g., house or car) involved in a loan procedure so that interests of both the borrower and the lender can be protected.

Thus, the need for improvement still exists.

### SUMMARY OF THE INVENTION

It is therefore one object of the invention to provide a method of intelligently verifying loan procedure implemented in a system of intelligently verifying loan procedure including an intelligent loan procedure platform system and an intelligent loan procedure management system.

The above and other objects, features and advantages of the invention will become apparent from the following detailed description taken with the accompanying drawings

### BRIEF DESCRIPTION OF THE DRAWINGS

FIG. 1 schematically depicts a portion of a system for implementing a method of the invention;

FIG. 2 schematically depicts the remaining portion of the system;

FIGS. 3A, 3B, 3C AND 3D schematically depict a first portion of a method of the invention respectively;

FIGS. 4A and 4B schematically depict a second portion of a method of the invention respectively;

FIGS. 5A, 5B, 5C and 5D schematically depict a third portion of a method of the invention respectively; and

FIGS. 6A and 6B schematically depict a fourth portion of a method of the invention respectively.

### DETAILED DESCRIPTION OF THE INVENTION

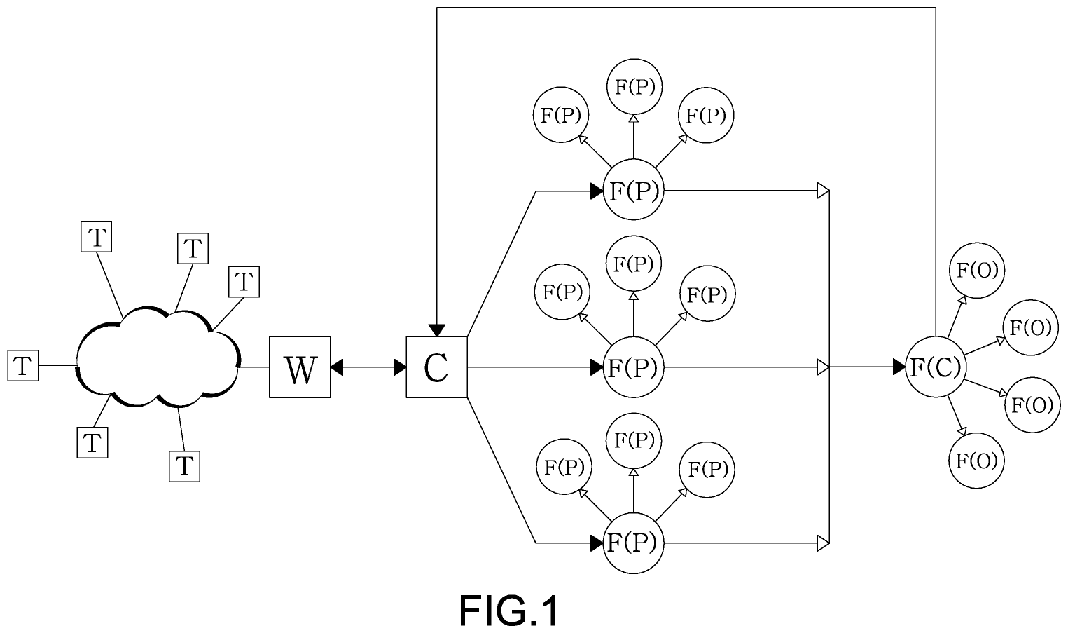

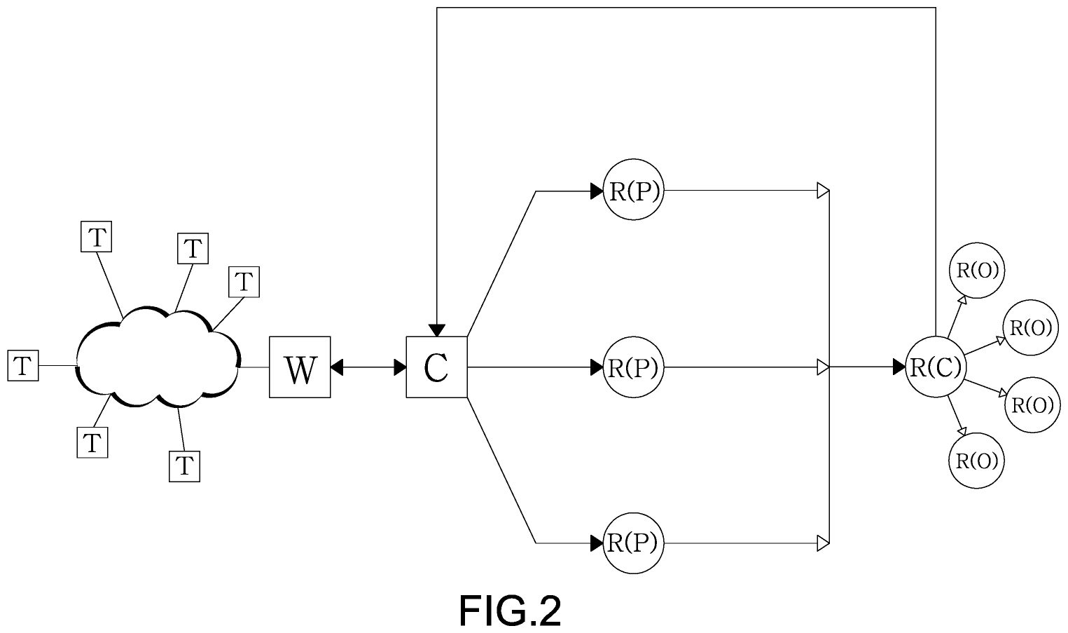

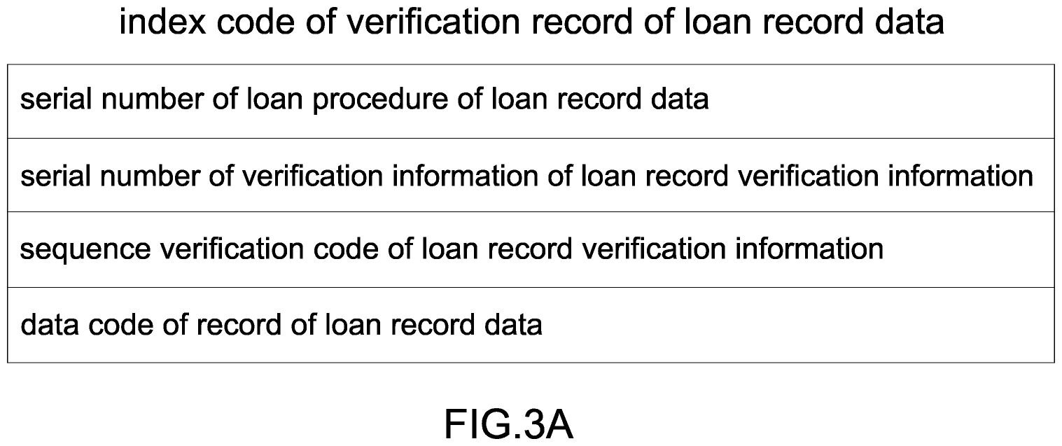

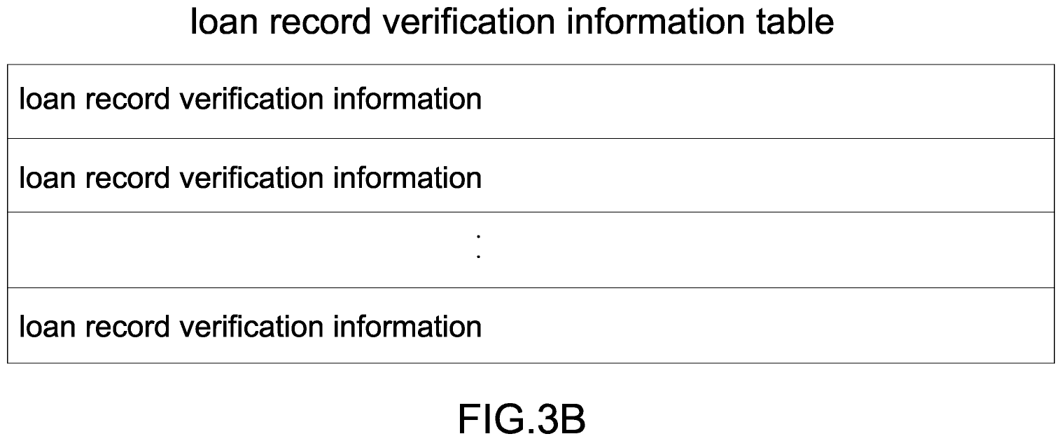

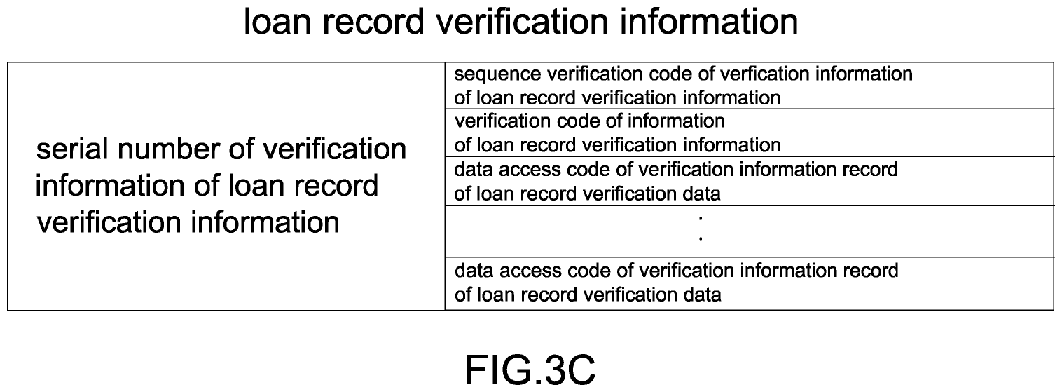

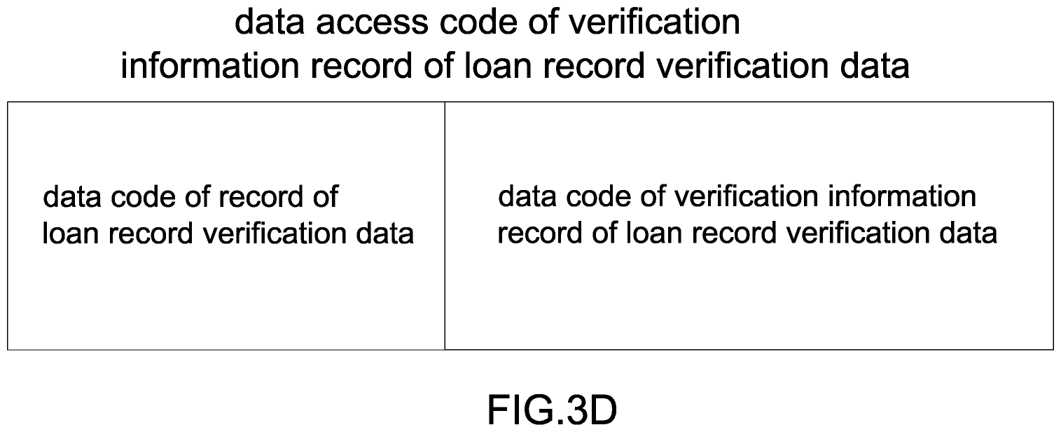

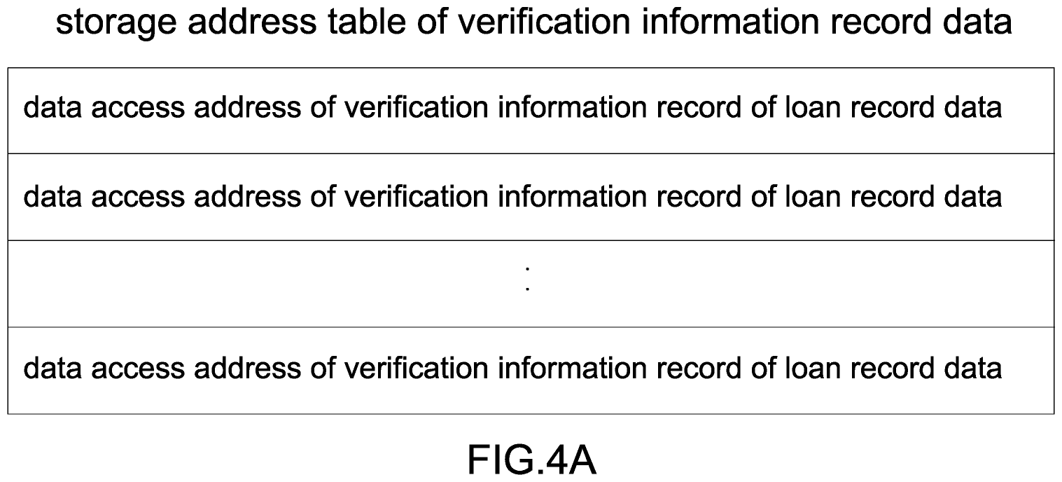

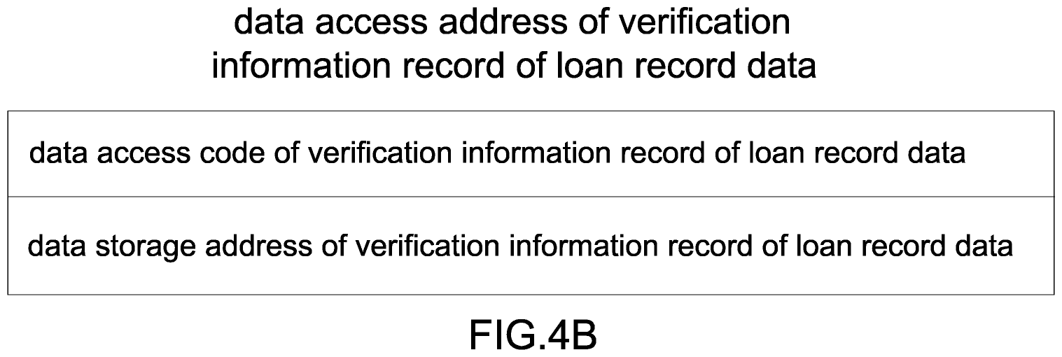

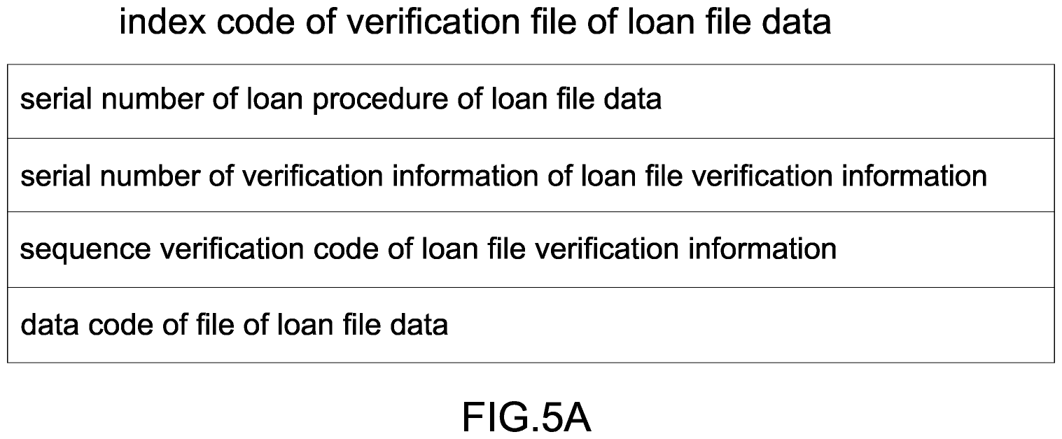

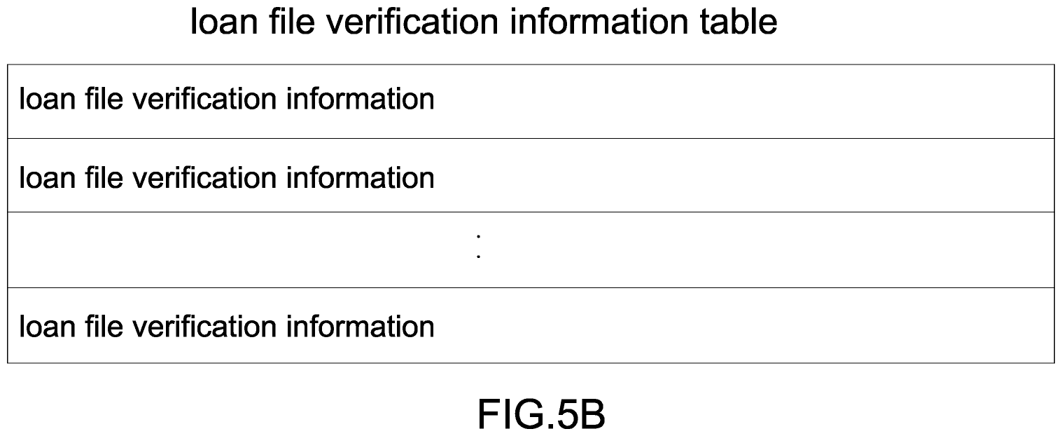

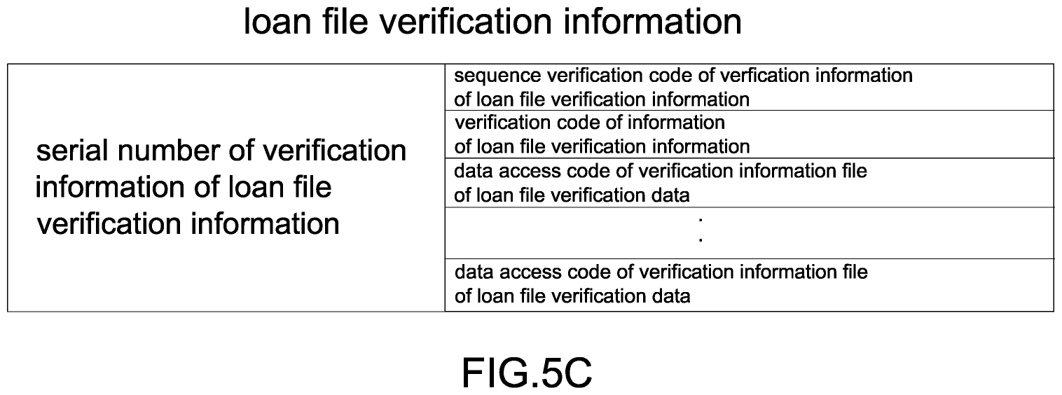

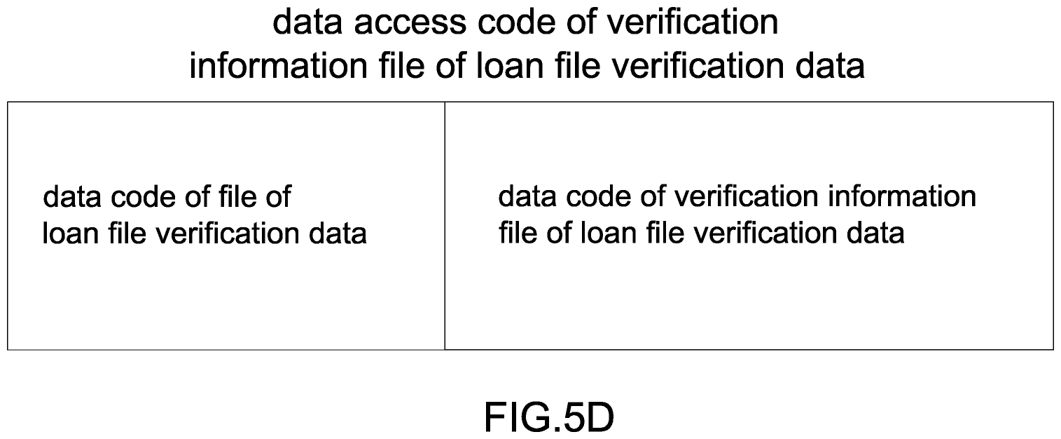

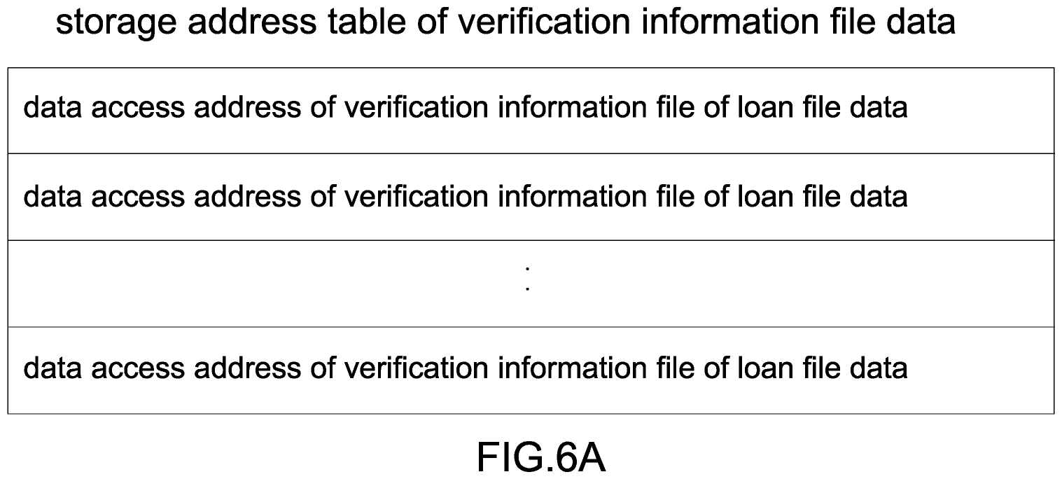

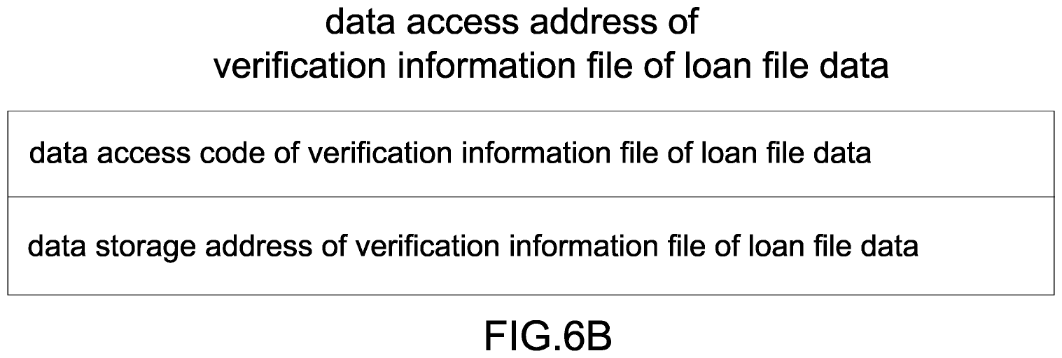

Referring to FIGS. 1 to 6B, a method of intelligently verifying loan procedure of the invention is implemented in a system of intelligently verifying loan procedure. The system of intelligently verifying loan procedure includes an intelligent loan procedure platform system and an intelligent loan procedure management system.

The intelligent loan procedure platform system includes an intelligent loan procedure platform server W and a plurality of remote terminals T. The intelligent loan procedure management system includes an intelligent loan procedure management server C, a plurality of loan data processing servers F(P), a loan data control server F(C), a plurality of loan data operation servers F(O), a plurality of loan procedure processing servers R(P), a loan procedure control server R(C) and a plurality of loan procedure operation servers R(O).

The intelligent loan procedure platform server W is connected to the internet and is connected to the intelligent loan procedure management server C via an intranet in which the remote terminals T configured to connected to the intelligent loan procedure platform server W via the internet. The intelligent loan procedure management server C, the loan data processing servers F(P), the loan data control server F(C), the loan data operation servers F(O), the loan procedure processing servers R(P), the loan procedure control servers R(C) and the loan procedure operation servers R(O) are interconnected via the intranet.

The intelligent loan procedure management server C includes a loan procedure proof information index table and a plurality of loan procedure data registers in which the loan procedure data registers include a plurality of loan application procedure data registers, a plurality of loan investigation procedure data registers, a plurality of loan appraisal procedure data registers, a plurality of loan agreement procedure data registers, a plurality of loan setting procedure data registers and a plurality of loan approval procedure data registers.

The loan data processing server F(P) includes a loan file register, a loan file division file register, a loan file division record register, a loan file proof information register to be updated, a proof information file storage data register, and a loan file proof information register in which the loan file proof information register includes a proof information file storage data storage address record table and a loan file proof information table. The loan file proof information table includes a plurality of loan file proof information.

The loan data control server F(C) includes a loan file storage data register, an operation verification data register, a proof information file storage data register, and a loan file proof information register in which the loan file proof information register includes a proof information file storage data storage address record table and a loan file proof information table. The loan file proof information table includes a plurality of loan file proof information.

The loan data operation server F(O) includes a loan file proof information register to be updated, a proof information file storage data register, and a loan file proof information register in which the loan file proof information register includes a proof information file storage data storage address record table and a loan file proof information table. The loan file proof information table includes loan file proof information.

The loan procedure processing server R(P) includes a loan record register, a loan record proof information register to be updated, a proof information record storage data register, and a loan record proof information register in which the loan record proof information register includes a proof information record storage data storage address record table and a loan record proof information table. The loan record proof information table includes loan record proof information.

The loan procedure control server R(C) includes a loan record storage data register, an operation verification data register, a proof information record storage data register, and a loan record proof information register in which the loan record proof information register includes a proof information record storage data storage address record table and a loan record proof information table. The loan record proof information table includes loan record proof information.

The loan procedure operation server R(O) includes a loan record proof information register to be updated, a proof information record storage data register, and a loan record proof information register in which the loan record proof information register includes a proof information record storage data storage address record table and a loan record proof information table. The loan record proof information table includes loan record proof information.

The method of intelligently verifying loan procedure comprises:

enabling a user to connect to the intelligent loan procedure platform server W via the remote terminal and internet, log in the intelligent loan procedure platform server W to verify a user name and a password, and obtain platform system member rights to for data communications; enabling the user to enter a loan procedure via the intelligent loan procedure platform server W in which the intelligent loan procedure platform server provides a user privilege share encoding and decoding data sequence and a personal encoding and decoding data sequence based on a non-symmetrical encoding and decoding algorithm in which the user is a borrower, a relative of the borrower, a lawyer, a real estate agent, a loan agent, a secretary, an appraisal specialist, or a bank employee;

enabling the user to set an intelligent loan procedure via the intelligent loan procedure platform server W so that the user becomes a loan procedure owner of an intelligent loan procedure in which the intelligent loan procedure includes a plurality of loan procedures including a loan application procedure, a loan investigation procedure, a loan appraisal procedure, a loan agreement procedure, a loan setting procedure, and a loan approval procedure; and in which the loan procedures of the intelligent loan procedure are performed sequentially;

in which in performing one of the loan procedures of the intelligent loan procedure, the loan procedure owner sends a system confirmation notice of joining the loan procedure to another user via the intelligent loan procedure platform server W to invite another user to join the loan procedure, after another user's positive reply to the system confirmation notice of joining the loan procedure, another user becomes a loan procedure participant of the loan procedure in which the loan procedure participant is allowed to only participate the invited loan procedure not other uninvited loan procedures;

in which in performing the loan procedure, the loan procedure owner or the loan procedure participant uses a non-symmetrical encoding and decoding algorithm to encode or decode data to ensure loan data access privilege and data safety so that the loan procedure owner or the loan procedure participant uses a shared encoded data sequence to encode data and uses a shared decoded data sequence to decode data or a personal encoded data sequence to encode data and uses a personal decoded data sequence to decode data;

in which the loan application procedure of the intelligent loan procedure uses the intelligent loan procedure platform server W to preset a plurality of loan files to be uploaded and a plurality of loan records to be loaded in which the loan files to be uploaded include a loan application and a financial statement, the loan records to be uploaded include an application procedure text record and an application procedure loan information record;

in which the loan investigation procedure uses the intelligent loan procedure platform server W to preset a plurality of loan files to be uploaded and a plurality of loan records to uploaded in which the loan files to be uploaded includes a personal credit report, the loan records to be uploaded include an investigation procedure text record and an investigation procedure loan information record;

In which the loan appraisal procedure uses the intelligent loan procedure platform server W to preset a plurality of loan files to be uploaded and a plurality of loan records to be uploaded in which the loan files to be uploaded include a collateral appraisal report, the loan records to be uploaded include an appraisal procedure text record and an appraisal procedure loan information record;

in which the loan agreement procedure uses the intelligent loan procedure platform server W to preset a plurality of loan files to be uploaded and a plurality of loan records to be uploaded in which the loan files to be uploaded include a loan agreement, an identification document, a driver license, a license application, and a house certificate, the loan records to be uploaded include an agreement procedure text record and an agreement procedure loan information record;

in which the loan setting procedure uses the intelligent loan procedure platform server W to preset a plurality of loan files to be uploaded and a plurality of loan records to be uploaded in which the loan files to be uploaded include an asset security setting application and a house certificate, the loan records to be uploaded include a setting procedure text record and a setting procedure loan information record;

in which the loan approval procedure uses the intelligent loan procedure platform server W to preset a plurality of loan files to be uploaded and a plurality of loan records to be uploaded in which the loan files to be uploaded include a loan item transfer slip, the loan records to be uploaded include an approval procedure text record and an approval procedure loan information record;

in which the loan procedure owner uses the intelligent loan procedure platform server W to add or delete the preset loan files to be uploaded in order to add or delete the loan file to be uploaded with respect to one of the loan procedures of the intelligent loan procedure, or add or delete the preset uploaded loan records to be uploaded in order to add or delete the loan records to be uploaded;

in which in a process the loan application procedure of the intelligent loan procedure uploads the loan files to be uploaded or the loan records to be uploaded to the intelligent loan procedure platform server W via the loan procedure owner or the loan procedure participant of the loan application procedure, the intelligent loan procedure platform server W sends same to the loan application procedure data register set by the intelligent loan procedure management server C via the intranet, and stores the loan files to be uploaded as loan proof files or store the loan records to be uploaded as loan proof records;

in which the loan application procedure uploads the loan files to be uploaded and the loan records to be uploaded to the loan application procedure data register of the intelligent loan procedure management server C and stores the corresponding loan proof files and the loan proof records, the loan procedure participant of the loan procedure owner or the loan application procedure checks the loan proof files and the loan proof records, and if it is correct the loan procedure participant of the loan procedure owner or the loan application procedure issues a confirmation notice of finishing the loan procedure;

in which after all of the loan procedure participants and the loan procedure owners of the loan application procedure have issued the confirmation notice of finishing the loan procedure, the loan application procedure is finished; the intelligent loan procedure management server C sets a corresponding loan procedure serial number of the loan application procedure data register and sends the loan procedure serial number to the intelligent loan procedure platform server W, the intelligent loan procedure platform server W sets the loan procedure serial number as a loan procedure serial number of the loan application procedure of the intelligent loan procedure; in which in a process the loan investigation procedure of the intelligent loan procedure, the loan files to be uploaded or the loan records to be uploaded of the loan investigation procedure are sent to the intelligent loan procedure platform server W via the loan procedure participant of the loan procedure owner or the loan investigation procedure, the intelligent loan procedure platform server W sends same to the loan investigation procedure data register of the intelligent loan procedure management server C via the intranet, stores the loan files to be uploaded as loan proof files or stores the loan records to be uploaded as loan proof records;

in which after the loan files to be uploaded and the loan records to be uploaded have been uploaded to the loan investigation procedure data register of the intelligent loan procedure management server C, the loan investigation procedure stores them as the loan proof files and the loan proof records, the loan procedure owner or the loan procedure participant of the loan investigation procedure checks the loan proof files and the loan proof records, and if it is correct, the loan procedure owner or the loan procedure participant of the loan investigation procedure sends a confirmation notice of finishing the loan procedure, after all of the loan procedure participants and the loan procedure owners of the loan investigation procedure have sent the confirmation notice of finishing the loan procedure, the loan investigation procedure is finished, the intelligent loan procedure management server C sets a corresponding loan procedure serial number with respect to the loan investigation procedure data register, sends the loan procedure serial number to the intelligent loan procedure platform server W, the intelligent loan procedure platform server W sends the loan procedure serial number as a loan procedure serial number of the loan investigation procedure of the intelligent loan procedure;

in which in a process the loan appraisal procedure of the intelligent loan procedure uploads the loan files to be uploaded and the loan records to be uploaded to the intelligent loan procedure platform server W via the loan procedure owner or the loan procedure participant the loan appraisal procedure, the intelligent loan procedure platform server W sends same to the corresponding loan appraisal procedure data register of the intelligent loan procedure management server C via the intranet, and stores the loan files to be uploaded as loan proof files or stores the loan records to be uploaded as loan proof records;

in which after the loan appraisal procedure has uploaded the loan files to be uploaded and the loan records to be uploaded to the loan appraisal procedure data register of the intelligent loan procedure management server C and has stored same as loan proof files and loan proof records, the loan procedure owner or the loan procedure participant of the loan appraisal procedure checks the loan proof files and the loan proof records, and if it is correct, the loan procedure owner or the loan procedure participant of the loan appraisal procedure issues a confirmation notice of finishing the loan procedure;

in which after all of the loan procedure participants and the loan procedure owners of the loan appraisal procedure have sent the confirmation notice of finishing the loan procedure, the loan appraisal procedure is finished, the intelligent loan procedure management server C sets a corresponding loan procedure serial number with respect to the loan appraisal procedure data register and sends the loan procedure serial number to the intelligent loan procedure platform server W, and the intelligent loan procedure platform server W sets the loan procedure serial number as a loan procedure serial number of the loan appraisal procedure of the intelligent loan procedure;

In which in a process the loan agreement procedure of the intelligent loan procedure uploads the loan files to be uploaded or the loan records to be uploaded to the intelligent loan procedure platform server W via the loan procedure owner or the loan procedure participant of the loan agreement procedure, the intelligent loan procedure platform server W sends same to a corresponding loan agreement procedure data register of the intelligent loan procedure management server C via the intranet, and stores the loan files to be uploaded as loan proof files or stores the loan records to be uploaded as loan proof records;

In which after the loan agreement procedure has uploaded the loan files to be uploaded and the loan records to be uploaded to the loan agreement procedure data register of the intelligent loan procedure management server C and has stored same as loan proof files and loan proof records, the loan procedure owner or the loan procedure participant of the loan agreement procedure checks the loan proof files and the loan proof records, and if it is correct, the loan procedure owner or the loan procedure participant of the loan agreement procedure issues a confirmation notice of finishing the loan procedure;

in which after all of the loan procedure participants and the loan procedure owners of the loan agreement procedure have sent the confirmation notice of finishing the loan procedure, the loan agreement procedure is finished, the intelligent loan procedure management server C sets a corresponding loan procedure serial number with respect to the loan agreement procedure data register and sends the loan procedure serial number to the intelligent loan procedure platform server W, and the intelligent loan procedure platform server W sets the loan procedure serial number as a loan procedure serial number of the loan agreement procedure of the intelligent loan procedure;

in which in a process the loan setting procedure of the intelligent loan procedure uploads the loan files to be uploaded or the loan records to be uploaded to the intelligent loan procedure platform server W via the loan procedure owner or the loan procedure participant of the loan setting procedure, the intelligent loan procedure platform server W sends same to the corresponding loan setting procedure data register of the intelligent loan procedure management server C via the intranet, and stores the loan files to be uploaded as loan proof files or stores the loan records to be uploaded as loan proof records;

in which after the loan setting procedure has uploaded the loan files to be uploaded and the loan records to be uploaded to the loan setting procedure data register of the intelligent loan procedure management server C and has stored same as loan proof files and loan proof records, the loan procedure owner or the loan procedure participant of the loan setting procedure checks the loan proof files and the loan proof records, and if it is correct, the loan procedure owner or the loan procedure participant of the loan setting procedure issues a confirmation notice of finishing the loan procedure;

in which after all of the loan procedure participants and the loan procedure owners of the loan setting procedure have sent the confirmation notice of finishing the loan procedure, the loan setting procedure is finished, the intelligent loan procedure management server C sets a corresponding loan procedure serial number with respect to the loan setting procedure data register and sends the loan procedure serial number to the intelligent loan procedure platform server W, and the intelligent loan procedure platform server W sets the loan procedure serial number as a loan procedure serial number of the loan setting procedure of the intelligent loan procedure;

in which in a process the loan approval procedure of the intelligent loan procedure uploads the loan files to be uploaded or the loan records to be uploaded to the intelligent loan procedure platform server W via the loan procedure owner or the loan procedure participant of the loan approval procedure, the intelligent loan procedure platform server W sends same to the corresponding loan approval procedure data register of the intelligent loan procedure management server C via the intranet, and stores the loan files to be uploaded as loan proof files or stores the loan records to be uploaded as loan proof records;

in which after the loan approval procedure has uploaded the loan files to be uploaded and the loan records to be uploaded to the loan approval procedure data register of the intelligent loan procedure management server C and has stored same as loan proof files and loan proof records, the loan procedure owner or the loan procedure participant of the loan approval procedure checks the loan proof files and the loan proof records, and if it is correct, the loan procedure owner or the loan procedure participant of the loan approval procedure issues a confirmation notice of finishing the loan procedure;

in which after all of the loan procedure participants and the loan procedure owners of the loan approval procedure have sent the confirmation notice of finishing the loan procedure, the loan approval procedure is finished, the intelligent loan procedure management server C sets a corresponding loan procedure serial number with respect to the loan approval procedure data register and sends the loan procedure serial number to the intelligent loan procedure platform server W, and the intelligent loan procedure platform server W sets the loan procedure serial number as a loan procedure serial number of the loan approval procedure of the intelligent loan procedure;

in which the intelligent loan procedure management server C sends the loan procedure serial number of the loan application procedure data register and the loan proof files to any of the loan data processing servers F(P) in a low operation storage work load via the intranet and stores same in the loan file register;

in which the loan data processing server F(P) performs a file division storage procedure on the loan proof files stored in the loan file register to divide the loan proof files into a plurality of loan files and stores same in the loan file division file register of each of other loan data processing servers F(P), and creates a corresponding loan file division record and stores same in the loan file division record register;

in which after the loan data processing server F(P) has performed the file division storage procedure on the loan proof files stored in the loan file register, the loan data processing server F(P) creates a corresponding loan file division record table based on the loan file division record of the loan file division record register, the loan data processing server F(P) performs a file encryption storage procedure on the loan file division record table so that a shared encryption and decryption data sequence of the loan procedure owner and each loan procedure participant of the loan application procedure are used to perform a data encryption storage of the loan file division record table and create a corresponding loan application procedure file storage data, further sends same from the loan application procedure file storage data to the loan data control server F(C) via the intranet and stores same in the loan file storage data register in which the loan data processing server F(P) sets a corresponding loan procedure serial number of the loan application procedure file storage data based on the loan procedure serial number of the loan application procedure data register, and the loan data processing server F(P) deletes data stored in both the loan file register and the loan file division record register;

in which the intelligent loan procedure management server C sends the loan procedure serial number and the loan proof files of the loan investigation procedure data register to any of the loan data processing servers F(P) in a low operation storage work load via the intranet and stores same in the loan file register;

in which the loan data processing server F(P) performs the file division storage procedure on the loan proof files stored in the loan file register to divide the loan proof files into a plurality of loan files and stores same in the loan file division file register of each of other loan data processing servers F(P), and creates a corresponding loan file division record and stores same in the loan file division record register;

in which after the loan data processing server F(P) has performed the file division storage procedure on the loan proof files stored in the loan file register, the loan data processing server F(P) creates a corresponding loan file division record table based on the loan file division record of the loan file division record register, the loan data processing server F(P) performs the file encryption storage procedure on the loan file division record table so that the shared encryption and decryption data sequence of the loan procedure owner and each of the loan procedure participants of the loan investigation procedure are used to perform a data encryption storage of the loan file division record table, create a corresponding loan investigation procedure file storage data, send the loan investigation procedure file storage data to the loan data control server F(C) via the intranet, and store same in the loan file storage data register in which the loan data processing server F(P) sets a corresponding loan procedure serial number of the loan investigation procedure file storage data based on the loan procedure serial number of the loan investigation procedure data register, and the loan data processing server F(P) deletes data stored in both the loan file register and the loan file division record register;

in which the intelligent loan procedure management server C sends the loan procedure serial number of the loan appraisal procedure data register and the loan proof files to any of the loan data processing servers F(P) in a low operation storage work load via the intranet and stores same in the loan file register;

in which the loan data processing server F(P) performs the file division storage procedure on the loan proof files stored in the loan file register to divide the loan proof files into a plurality of loan files and stores same in the loan file division file register of each of other loan data processing servers F(P), and creates a corresponding loan file division record and stores same in the loan file division record register;

in which after the loan data processing server F(P) has performed the file division storage procedure on the loan proof files stored in the loan file register, the loan data processing server F(P) creates a corresponding loan file division record table based on the loan file division record of the loan file division record register, the loan data processing server F(P) performs a file encryption storage procedure on the loan file division record table so that a shared encryption and decryption data sequence of the loan procedure owner and each loan procedure participant of the loan application procedure are used to perform a data encryption storage of the loan file division record table and create a corresponding loan application procedure file storage data, further sends same from the loan application procedure file storage data to the loan data control server F(C) via the intranet and stores same in the loan file storage data register in which the loan data processing server F(P) sets a corresponding loan procedure serial number of the loan application procedure file storage data based on the loan procedure serial number of the loan application procedure data register, and the loan data processing server F(P) deletes data stored in both the loan file register and the loan file division record register;

in which the intelligent loan procedure management server C sends the loan procedure serial number of the loan appraisal procedure data register and the loan proof files to any of the loan data processing servers F(P) in a low operation storage work load via the intranet and stores same in the loan file register;

in which the loan data processing server F(P) performs the file division storage procedure on the loan proof files stored in the loan file register to divide the loan proof files into a plurality of loan files and stores same in the loan file division file register of each of other loan data processing servers F(P), and creates a corresponding loan file division record and stores same in the loan file division record register;

in which after the loan data processing server F(P) has performed the file division storage procedure on the loan proof files stored in the loan file register, the loan data processing server F(P) creates a corresponding loan file division record table based on the loan file division record of the loan file division record register, the loan data processing server F(P) performs the file encryption storage procedure on the loan file division record table so that the shared encryption and decryption data sequence of the loan procedure owner and each of the loan procedure participants of the loan investigation procedure are used to perform a data encryption storage of the loan file division record table, create a corresponding loan investigation procedure file storage data, send the loan investigation procedure file storage data to the loan data control server F(C) via the intranet, and store same in the loan file storage data register in which the loan data processing server F(P) sets a corresponding loan procedure serial number of the loan investigation procedure file storage data based on the loan procedure serial number of the loan investigation procedure data register, and the loan data processing server F(P) deletes data stored in both the loan file register and the loan file division record register;

in which the intelligent loan procedure management server C sends the loan procedure serial number of the loan appraisal procedure data register and the loan proof files to any of the loan data processing servers F(P) in a low operation storage work load via the intranet and stores same in the loan file register;

in which the loan data processing server F(P) performs the file division storage procedure on the loan proof files stored in the loan file register to divide the loan proof files into a plurality of loan files and stores same in the loan file division file register of each of other loan data processing servers F(P), and creates a corresponding loan file division record and stores same in the loan file division record register;

in which after the loan data processing server F(P) has performed the file division storage procedure on the loan proof files stored in the loan file register, the loan data processing server F(P) creates a corresponding loan file division record table based on the loan file division record of the loan file division record register, the loan data processing server F(P) performs the file encryption storage procedure on the loan file division record table so that the shared encryption and decryption data sequence of the loan procedure owner and each of the loan procedure participants of the loan setting procedure are used to perform a data encryption storage of the loan file division record table, create a corresponding loan setting procedure file storage data, send the loan setting procedure file storage data to the loan data control server F(C) via the intranet, and store same in the loan file storage data register in which the loan data processing server F(P) sets a corresponding loan procedure serial number of the loan setting procedure file storage data based on the loan procedure serial number of the loan setting procedure data register, and the loan data processing server F(P) deletes data stored in both the loan file register and the loan file division record register;

in which the intelligent loan procedure management server C sends the loan procedure serial number of the loan approval procedure data register and the loan proof files to any of the loan data processing servers F(P) in a low operation storage work load via the intranet and stores same in the loan file register;

in which the loan data processing server F(P) performs the file division storage procedure on the loan proof files stored in the loan file register to divide the loan proof files into a plurality of loan files and stores same in the loan file division file register of each of other loan data processing servers F(P), and creates a corresponding loan file division record and stores same in the loan file division record register;

in which after the loan data processing server F(P) has performed the file division storage procedure on the loan proof files stored in the loan file register, the loan data processing server F(P) creates a corresponding loan file division record table based on the loan file division record of the loan file division record register, the loan data processing server F(P) performs the file encryption storage procedure on the loan file division record table so that the shared encryption and decryption data sequence of the loan procedure owner and each of the loan procedure participants of the loan approval procedure are used to perform a data encryption storage of the loan file division record table, create a corresponding loan approval procedure file storage data, send the loan approval procedure file storage data to the loan data control server F(C) via the intranet, and store same in the loan file storage data register in which the loan data processing server F(P) sets a corresponding loan procedure serial number of the loan approval procedure file storage data based on the loan procedure serial number of the loan approval procedure data register, and the loan data processing server F(P) deletes data stored in both the loan file register and the loan file division record register;

in which the loan file storage data register of the loan data control server F(C) stores loan file storage data in which the loan file storage data is the loan application procedure file storage data, the loan investigation procedure file storage data, the loan appraisal procedure file storage data, the loan agreement procedure file storage data, the loan setting procedure file storage data or the loan approval procedure file storage data;

in which the loan data control server F(C) sequentially accesses the loan file storage data stored in the loan file storage data register based on operation execution sequence of data operation verification period operation of the system and operation data and stores same in the operation verification data register, and in the data operation verification period, the loan data control server F(C) sequentially performs a storage data operation verification procedure, an added proof information procedure, and an updated proof information procedure on the loan file storage data stored in the operation verification data register;

in which the storage data operation verification procedure includes a first storage data operation verification procedure, a second storage data operation verification procedure, and a third storage data operation verification procedure;

in which the first storage data operation verification procedure including the loan data control server F(C) sends the loan file storage data of the operation verification data register to the loan data operation server F(O), the loan data operation server F(O) performs a data encryption operation on the loan file storage data based on a system setting data encryption algorithm, and sends a value of the completed encryption operation to the loan data control server F(C);

in which the loan data control server F(C) analyzes same and verifies that at least 50% of the value of the encryption operation is the same, the loan data control server F(C) correspondingly sets the value of the encryption operation as a file storage data operation code of the loan file storage data so as to finish an encoding procedure of the storage data of the loan file storage data;

in which the loan data control server F(C) activates the loan data operation server F(O) to finish the storage data encoding procedure of the loan file storage data of the operation verification data register so as to set a corresponding file storage data operation code of the loan file storage data;

in which the second storage data operation verification procedure including the loan data control server F(C) sends the file storage data operation code of the loan file storage data to the loan data operation server F(O), the loan data operation server F(O) performs a data encryption operation on the loan file storage data based on a system setting data encryption algorithm, and sends a value of the completed encryption operation to the loan data control server F(C);

in which the loan data control server F(C) analyzes same and verifies that at least 50% of the value of the encryption operation is the same, the loan data control server F(C) correspondingly sets the value of the encryption operation as a file storage data code of the loan file storage data so as to finish an encoding procedure of the storage data of the loan file storage data;

in which the third storage data operation verification procedure including the loan data control server F(C) sends the file storage data code and the file storage data operation code of the loan file storage data to the loan data operation server F(O), the loan data operation server F(O) performs a data encryption operation on the loan file storage data based on a system setting data encryption algorithm, and sends a value of the completed encryption operation to the loan data control server F(C);

in which the loan data control server F(C) analyzes same and verifies that at least 50% of the value of the encryption operation is the same, the loan data control server F(C) correspondingly sets the value of the encryption operation as a proof information file storage data access code of the loan file storage data so as to finish a proof information encoding procedure of the loan file storage data;

in which the loan data control server F(C) activates the loan data operation server F(O) to finish the proof information encoding procedure of the loan file storage data of the operation verification data register so as to set a corresponding proof information file storage data access code of the loan file storage data;

in which the added proof information procedure includes a first added proof information procedure, a second added proof information procedure, a third added proof information procedure, a fourth added proof information procedure, and a fifth added proof information procedure;

in which the first added proof information procedure including the loan data control server F(C) stores the loan file storage data of the operation verification data register in the proof information file storage data register, sets a corresponding storage address as a proof information file storage data storage address of the loan file storage data, uses the proof information file storage data access code of the loan file storage data and the proof information file storage data storage address to set a proof information file storage data access address of the loan file storage data so as to finish the proof information storage record procedure of the loan file storage data;

in which after the loan data control server F(C) has finished the proof information storage record procedure of the loan file storage data of the operation verification data register, the loan data control server F(C) sets a corresponding proof information file storage data access address of the loan file storage data, and uses the proof information file storage data access address of the loan file storage data to create a storage record in the proof information file storage data storage address record table of the loan file proof information register;

in which the second added proof information procedure including the loan data control server F(C) sets the file storage data operation code of the loan file storage data and the proof information file storage data access code as a proof information file storage data access code of the loan file storage data to finish the proof information access code encoding procedure of the loan file storage data;

in which after the loan data control server F(C) has finished the proof information access code encoding procedure of the loan file storage data of the operation verification data register, the loan data control server F(C) sets a corresponding proof information file storage data access code of the loan file storage data;

in which the third added proof information procedure including the loan data control server F(C) sequentially sets a proof information serial number of the loan file proof information based on a serial number of a storage record in the loan file proof information of the loan file proof information table of the loan file proof information register, and sets an information verification code of the last loan file proof information of the loan file proof information table as a proof information sequence verification code of the loan file proof information, and sets the file storage data code as an information verification code of the loan file proof information;

in which the fourth added proof information procedure including the loan data control server F(C) sets the proof information serial number of the loan file proof information, the proof information sequence verification code, the information verification code, and the proof information file storage data access code of the loan file storage data as contents of the loan file proof information, and stores same in the loan file proof information table, and the loan file proof information is the last loan file proof information of the loan file proof information table;

in which the loan file proof information of the loan file proof information table sequentially stores a record in the loan file proof information table based on the set sequence of the loan file proof information, and creates a loan file proof information sequence;

in which the fifth added proof information procedure including the loan data control server F(C) sets the loan procedure serial number of the loan file storage data, the proof information serial number of the loan file proof information, the proof information sequence verification code, and the file storage data operation code of the loan file storage data as a proof information file storage data index code of the loan file storage data to finish proof information index encoding procedure of the loan file storage data;

in which after the loan data control server F(C) has finished the loan file storage data of the proof information index encoding procedure of the operation verification data register, the loan data control server F(C) sets a corresponding proof information file storage data index code of the loan file storage data, and sends the proof information file storage data index code of the loan file storage data to the intelligent loan procedure management server C via the intranet;

in which the intelligent loan procedure management server C analyzes the loan procedure serial number of the loan file storage data of the proof information file storage data index code based on the loan file storage data to verify that the loan procedure data register has same loan procedure serial number, stores the proof information file storage data index code of the loan file storage data in the loan procedure data register, and stores the proof information file storage data index code of the loan file storage data in the corresponding loan procedure data register;

in which the loan procedure data register is the loan application procedure data register, the loan investigation procedure data register, the loan appraisal procedure data register, the loan agreement procedure data register, the loan setting procedure data register, or the loan approval procedure data register;

in which the updated proof information procedure includes a first updated proof information procedure and a second updated proof information procedure;

in which the first updated proof information procedure including the loan data control server F(C) sends the loan file storage data of the operation verification data register, the proof information file storage data access code of the loan file storage data, and the loan file proof information to the loan data processing server F(P) via the intranet, and stores same in both the updated loan file proof information register of the loan data processing server F(P) and the updated loan file proof information register of the loan data operation server F(O); and the loan data control server F(C) deletes data stored in the operation verification data register;

in which the second updated proof information procedure including the loan data processing server F(P) stores the loan file storage data of the updated loan file proof information register in the proof information file storage data register, sets a corresponding storage address as a proof information file storage data storage address of the loan file storage data, sets the proof information file storage data access code of the loan file storage data and the proof information file storage data storage address as a proof information file storage data access address of the loan file storage data, and finishes proof information storage record procedure of the loan file storage data;

in which after the loan data processing server F(P) has finished the proof information storage record procedure of the loan file storage data of the updated loan file proof information register, the loan data processing server F(P) sets a corresponding proof information file storage data access address of the loan file storage data;

in which the loan data processing server F(P) stores the proof information file storage data access address of the loan file storage data in the proof information file storage data storage address record table of the loan file proof information register;

in which the loan data processing server F(P) sets the loan file proof information of the updated loan file proof information register in the loan file proof information table of the loan file proof information register, the loan file proof information is the last loan file proof information of the loan file proof information table, and finishes the loan file proof information updating procedure;

in which the loan file proof information of the loan file proof information table is sequentially stored in the loan file proof information table based on the set sequence of the loan file proof information, creates a loan file proof information sequence, and the loan data processing server F(P) deletes data stored in the updated loan file proof information register;

in which the loan data operation server F(O) stores the loan file storage data of the updated loan file proof information register in the proof information file storage data register, sets a corresponding storage address as a proof information file storage data storage address of the loan file storage data, sets the proof information file storage data access code of the loan file storage data and the proof information file storage data storage address as a proof information file storage data access address of the loan file storage data, and finishes the proof information storage record procedure of the loan file storage data;

in which after the loan data operation server F(O) has finished the loan file storage data of the proof information storage record procedure of the updated loan file proof information register, the loan data operation server F(O) sets a corresponding proof information file storage data access address of the loan file storage data, and stores the proof information file storage data access address of the loan file storage data in the proof information file storage data storage address record table of the loan file proof information register;

in which the loan data operation server F(O) sets the loan file proof information of the updated loan file proof information register in the loan file proof information table of the loan file proof information register, the loan file proof information is the last loan file proof information of the loan file proof information table, and finishes the loan file proof information updating procedure;

in which the loan file proof information of the loan file proof information table is sequentially stored in the loan file proof information table based on the set sequence of the loan file proof information, creates a loan file proof information sequence, and the loan data processing server F(P) deletes data stored in the updated loan file proof information register;

in which after the loan data processing server F(P) and the loan data operation server F(O) has finished the loan file proof information updating procedure respectively, the proof information procedure is updated;

in which contents of the loan file proof information table of the loan file proof information register of the loan data processing server F(P) and contents of the loan file proof information table of the loan file proof information register of the loan data operation server F(O) are the same as that of the loan file proof information table of the loan file proof information register of the loan data control server F(C) so as to simultaneously and synchronously update the loan file proof information table;

in which the intelligent loan procedure management server C sends the loan procedure serial number of the loan application procedure data register, the loan proof records and the proof information file storage data index code of the loan application procedure file storage data to any of the loan procedure data processing servers R(P) in a low operation storage work load via the intranet and stores same in the loan record register;

in which the loan procedure processing server R(P) performs a record encryption storage procedure on the loan proof records of the loan record register and the proof information file storage data index code of the loan application procedure file storage data so that a shared encryption and decryption data sequence of the loan procedure owner and each loan procedure participant of the loan application procedure are used to perform a data encryption storage of the loan proof records and the proof information file storage data index code of the loan application procedure file storage data and create a corresponding loan application procedure record storage data; and further sends same from the loan application procedure record storage data to the loan data control server R(C) via the intranet and stores same in the loan record storage data register;

in which the loan procedure processing server R(P) sets a corresponding loan procedure serial number of the loan application procedure record storage data based on the loan procedure serial number of the loan application procedure data register, and the loan procedure processing server R(P) deletes data stored in the loan record register;

in which the intelligent loan procedure management server C sends the loan procedure serial number of the loan investigation procedure data register, the loan proof records and the proof information file storage data index code of the loan investigation procedure file storage data to any of the loan procedure data processing servers R(P) in a low operation storage work load via the intranet and stores same in the loan record register;

in which the loan procedure processing server R(P) performs a record encryption storage procedure on the loan proof records of the loan record register and the proof information file storage data index code of the loan investigation procedure file storage data so that a shared encryption and decryption data sequence of the loan procedure owner and each loan procedure participant of the loan application procedure are used to perform a data encryption storage of the loan proof records and the proof information file storage data index code of the loan investigation procedure file storage data and create a corresponding loan investigation procedure record storage data; and further sends same from the loan investigation procedure record storage data to the loan data control server R(C) via the intranet and stores same in the loan record storage data register;

in which the loan procedure processing server R(P) sets a corresponding loan procedure serial number of the loan investigation procedure record storage data based on the loan procedure serial number of the loan investigation procedure data register, and the loan procedure processing server R(P) deletes data stored in the loan record register;

in which the intelligent loan procedure management server C sends the loan procedure serial number of the loan appraisal procedure data register, the loan proof records and the proof information file storage data index code of the loan appraisal procedure file storage data to any of the loan procedure data processing servers R(P) in a low operation storage work load via the intranet and stores same in the loan record register;

in which the loan procedure processing server R(P) performs a record encryption storage procedure on the loan proof records of the loan record register and the proof information file storage data index code of the loan appraisal procedure file storage data so that a shared encryption and decryption data sequence of the loan procedure owner and each loan procedure participant of the loan appraisal procedure are used to perform a data encryption storage of the loan proof records and the proof information file storage data index code of the loan appraisal procedure file storage data and create a corresponding loan appraisal procedure record storage data; and further sends same from the loan appraisal procedure record storage data to the loan data control server R(C) via the intranet and stores same in the loan record storage data register;

in which the loan procedure processing server R(P) sets a corresponding loan procedure serial number of the loan appraisal procedure record storage data based on the loan procedure serial number of the loan appraisal procedure data register, and the loan procedure processing server R(P) deletes data stored in the loan record register;

in which the intelligent loan procedure management server C sends the loan procedure serial number of the loan agreement procedure data register, the loan proof records and the proof information file storage data index code of the loan agreement procedure file storage data to any of the loan procedure data processing servers R(P) in a low operation storage work load via the intranet and stores same in the loan record register;

in which the loan procedure processing server R(P) performs a record encryption storage procedure on the loan proof records of the loan record register and the proof information file storage data index code of the loan agreement procedure file storage data so that a shared encryption and decryption data sequence of the loan procedure owner and each loan procedure participant of the loan agreement procedure are used to perform a data encryption storage of the loan proof records and the proof information file storage data index code of the loan agreement procedure file storage data and create a corresponding loan agreement procedure record storage data; and further sends same from the loan agreement procedure record storage data to the loan data control server R(C) via the intranet and stores same in the loan record storage data register;

in which the loan procedure processing server R(P) sets a corresponding loan procedure serial number of the loan agreement procedure record storage data based on the loan procedure serial number of the loan agreement procedure data register, and the loan procedure processing server R(P) deletes data stored in the loan record register;

in which the intelligent loan procedure management server C sends the loan procedure serial number of the loan setting procedure data register, the loan proof records and the proof information file storage data index code of the loan setting procedure file storage data to any of the loan procedure data processing servers R(P) in a low operation storage work load via the intranet and stores same in the loan record register;

in which the loan procedure processing server R(P) performs a record encryption storage procedure on the loan proof records of the loan record register and the proof information file storage data index code of the loan setting procedure file storage data so that a shared encryption and decryption data sequence of the loan procedure owner and each loan procedure participant of the loan setting procedure are used to perform a data encryption storage of the loan proof records and the proof information file storage data index code of the loan setting procedure file storage data and create a corresponding loan setting procedure record storage data; and further sends same from the loan setting procedure record storage data to the loan data control server R(C) via the intranet and stores same in the loan record storage data register;

in which the loan procedure processing server R(P) sets a corresponding loan procedure serial number of the loan setting procedure record storage data based on the loan procedure serial number of the loan setting procedure data register, and the loan procedure processing server R(P) deletes data stored in the loan record register;

in which the intelligent loan procedure management server C sends the loan procedure serial number of the loan approval procedure data register, the loan proof records and the proof information file storage data index code of the loan approval procedure file storage data to any of the loan procedure data processing servers R(P) in a low operation storage work load via the intranet and stores same in the loan record register;

in which the loan procedure processing server R(P) performs a record encryption storage procedure on the loan proof records of the loan record register and the proof information file storage data index code of the loan approval procedure file storage data so that a shared encryption and decryption data sequence of the loan procedure owner and each loan procedure participant of the loan approval procedure are used to perform a data encryption storage of the loan proof records and the proof information file storage data index code of the loan approval procedure file storage data and create a corresponding loan approval procedure record storage data; and further sends same from the loan approval procedure record storage data to the loan data control server R(C) via the intranet and stores same in the loan record storage data register;

in which the loan procedure processing server R(P) sets a corresponding loan procedure serial number of the loan approval procedure record storage data based on the loan procedure serial number of the loan approval procedure data register, and the loan procedure processing server R(P) deletes data stored in the loan record register;

in which the loan record storage data register of the loan procedure control server R(C) stores a plurality of loan record storage data in which the loan record storage data is the loan application procedure record storage data, the loan investigation procedure record storage data, the loan appraisal procedure record storage data, the loan agreement procedure record storage data, the loan setting procedure record storage data, or the loan approval procedure record storage data;

in which the loan procedure control server R(C) sequentially accesses the loan file storage data stored in the loan record storage data register based on operation execution sequence of data operation verification period operation of the system and operation data and stores same in the operation verification data register, and in the data operation verification period, the loan procedure control server R(C) sequentially performs a storage data operation verification procedure, an added proof information procedure, and an updated proof information procedure on the loan record storage data stored in the operation verification data register;

in which the storage data operation verification procedure includes a first storage data operation verification procedure, a second storage data operation verification procedure, and a third storage data operation verification procedure;

in which the first storage data operation verification procedure including the loan procedure control server R(C) sends the loan record storage data of the operation verification data register to the loan data operation server R(O), the loan data operation server R(O) performs a data encryption operation on the loan record storage data based on a system setting data encryption algorithm, and sends a value of the completed encryption operation to the loan data control server R(C);

in which the loan data control server R(C) analyzes same and verifies that at least 50% of the value of the encryption operation is the same, the loan data control server R(C) correspondingly sets the value of the encryption operation as a record storage data operation code of the loan record storage data so as to finish an encoding procedure of the storage data of the loan record storage data;

in which the loan data control server R(C) activates the loan data operation server R(O) to finish the proof information encoding procedure of the loan record storage data of the operation verification data register so as to set a corresponding proof information record storage data access code of the loan record storage data;

in which the second storage data operation verification procedure including the loan procedure control server R(C) sends the record storage data operation code of the loan record storage data to the loan data operation server R(O), the loan data operation server R(O) performs a data encryption operation on the loan record storage data based on a system setting data encryption algorithm, and sends a value of the completed encryption operation to the loan data control server R(C);

in which the loan data control server R(C) analyzes same and verifies that at least 50% of the value of the encryption operation is the same, the loan data control server R(C) correspondingly sets the value of the encryption operation as a record storage data operation code of the loan record storage data;

in which the third storage data operation verification procedure including the loan procedure control server R(C) sends the file storage data code and the file storage data operation code of the loan file storage data to the loan data operation server R(O), the loan data operation server R(O) performs a data encryption operation on the loan file storage data based on a system setting data encryption algorithm, and sends a value of the completed encryption operation to the loan data control server R(C);

in which the loan data control server R(C) analyzes same and verifies that at least 50% of the value of the encryption operation is the same, the loan data control server R(C) correspondingly sets the value of the encryption operation as a proof information file storage data access code of the loan file storage data so as to finish a proof information encoding procedure of the loan file storage data;

in which the loan data control server R(C) activates the loan data operation server R(O) to finish the proof information encoding procedure of the loan file storage data of the operation verification data register so as to set a corresponding proof information file storage data access code of the loan file storage data;

in which the loan procedure control server R(C) analyzes same and verifies that at least 50% of the value of the encryption operation is the same, the loan data control server R(C) correspondingly sets the value of the encryption operation as a proof information file storage data access code of the loan record storage data so as to finish a proof information encoding procedure of the loan record storage data;

in which the loan data control server R(C) activates the loan data operation server R(O) to finish the proof information encoding procedure of the loan record storage data of the operation verification data register so as to set a corresponding proof information file storage data access code of the loan record storage data;

in which the added proof information procedure includes a first added proof information procedure, a second added proof information procedure, a third added proof information procedure, a fourth added proof information procedure, and a fifth added proof information procedure;

in which the first added proof information procedure including the loan procedure control server R(C) stores the loan record storage data of the operation verification data register in the proof information record storage data register, sets a corresponding storage address as the proof information record storage data storage address of the loan record storage data, and sets the proof information record storage data access code of the loan record storage data and the proof information record storage data storage address as a proof information record storage data access address of the loan record storage data so as to finish the proof information storage record procedure of the loan record storage data;

in which after the loan procedure control server R(C) has finished the proof information storage record procedure of the loan record storage data of the operation verification data register, the loan procedure control server R(C) sets a corresponding proof information record storage data access address of the loan record storage data;

in which the loan procedure control server R(C) stores the proof information record storage data access address of the loan record storage data in the proof information record storage data storage address record table of the loan record proof information register;

in which the second added proof information procedure including the loan procedure control server R(C) sets the record storage data code of the loan record storage data and the proof information record storage data access code as a proof information record storage data access code of the loan record storage data to finish the proof information access code encoding procedure of the loan record storage data;

in which after the loan procedure control server R(C) has finished the proof information access code encoding procedure of the loan record storage data of the operation verification data register, the loan procedure control server R(C) sets a corresponding proof information record storage data access code of the loan record storage data;

in which the third added proof information procedure including the loan procedure control server R(C) sequentially sets a proof information serial number of the added loan record proof information based on a serial number of the loan record proof information stored in the loan record proof information table of the loan record proof information register, sets the information verification code of the last loan record proof information of the loan record proof information table as a proof information sequence verification code of the added loan record proof information, and sets the record storage data code as an information verification code of the added loan record proof information;

in which the fourth added proof information procedure including the loan procedure control server R(C) sets the proof information serial number of the added loan record proof information, the proof information sequence verification code, the information verification code, and the proof information record storage data access code of the loan record storage data as contents of the added loan record proof information and stores same in the loan record proof information table, and the added loan record proof information is the last loan record proof information of the loan record proof information table;

in which the loan record proof information of the loan record proof information table sequentially stores records in the loan record proof information table based on the set sequence of the loan record proof information, and creates a loan record proof information sequence;

in which the fifth added proof information procedure including the loan procedure control server R(C) sets the loan procedure serial number of the loan record storage data, the proof information serial number of the added loan record proof information, the proof information sequence verification code, and the record storage data code of the loan record storage data as a proof information record storage data index code of the loan record storage data so as to finish the proof information index encoding procedure of the loan record storage data;

in which after the loan procedure control server R(C) has finished the proof information index encoding procedure of the loan record storage data of the operation verification data register, the loan procedure control server R(C) sets a corresponding proof information record storage data index code of the loan record storage data, the loan procedure control server R(C) sends the proof information record storage data index code of the loan record storage data to the intelligent loan procedure management server C via the intranet, and stores same in the loan procedure proof information index table;

in which the intelligent loan procedure management server C analyzes the loan procedure serial number of the loan record storage data of the proof information record storage data index code based on the added loan record storage data in the loan procedure proof information index table and verifies that the loan procedure data register has the same loan procedure serial number, deletes data stored in the loan procedure data register, and sends the loan procedure serial number of the loan record storage data stored in the proof information record storage data index code of the added loan record storage data to the intelligent loan procedure platform server W;

in which the intelligent loan procedure platform server W analyzes the loan procedure serial number of the loan record storage data of the proof information record storage data index code based on the loan procedure serial number and verifies that the loan procedure of the intelligent loan procedure has the same loan procedure serial number, and sets the loan procedure as a finished data proof procedure;

in which the loan procedure is the loan application procedure, the loan investigation procedure, the loan appraisal procedure, the loan agreement procedure, the loan setting procedure, or the loan approval procedure;

in which the update proof information procedure includes a first updated proof information procedure and a second updated proof information procedure;

in which the first updated proof information procedure including the loan procedure control server R(C) sends the loan record storage data of the operation verification data register and the loan record proof information of the proof information record storage data access code of the loan record storage data via the intranet and stores same in the updated loan record proof information register of the loan procedure processing server R(P) and the updated loan record proof information register of the loan procedure operation server R(O), and the loan procedure control server R(C) deletes data stored in the operation verification data register;

in which the second updated proof information procedure including the loan procedure processing server R(P) stores the loan record storage data of the updated loan record proof information register in the proof information record storage data register, sets a corresponding storage address as a proof information record storage data storage address of the loan record storage data, sets the proof information record storage data access code of the loan record storage data and the proof information record storage data storage address as a proof information record storage data access address of the loan record storage data, and finishes the proof information storage record procedure of the loan record storage data;

in which after the loan procedure processing server R(P) has finished the proof information storage record procedure of the loan record storage data of the updated loan record proof information register, the loan procedure processing server R(P) sets a corresponding proof information record storage data access address of the loan record storage data;

in which the loan procedure processing server R(P) stores the proof information record storage data access address of the loan record storage data in the proof information record storage data storage address record table of the loan record proof information register, the loan procedure processing server R(P) sets the added loan record proof information of the updated loan record proof information register in the loan record proof information table of the loan record proof information register, and the added loan record proof information is the last loan record proof information of the loan record proof information table so as to finish the loan record proof information updating procedure of the loan procedure processing server R(P);

in which the loan record proof information of the loan record proof information table sequentially stores records in the loan record proof information table based on the set sequence of the loan record proof information and creates a loan record proof information sequence, and the loan procedure processing server R(P) deletes data stored in the updated loan record proof information register;

in which the loan procedure operation server R(O) stores the loan record storage data of the updated loan record proof information register in the proof information record storage data register and sets the corresponding storage address as a proof information record storage data storage address of the loan record storage data, and sets the proof information record storage data access code of the loan record storage data and the proof information record storage data storage address as a the proof information record storage data access address of the loan record storage data so as to finish the proof information storage record procedure of the loan record storage data;

in which after the loan procedure operation server R(O) has finished the proof information storage record procedure of the loan record storage data of the updated loan record proof information register, the loan procedure operation server R(O) sets a corresponding proof information record storage data access address of the loan record storage data, the loan procedure operation server R(O) stores the proof information record storage data access address of the loan record storage data in the proof information record storage data storage address record table of the loan record proof information register, the loan procedure operation server R(O) sets the added loan record proof information of the updated loan record proof information register in the loan record proof information table of the loan record proof information register, and the added loan record proof information is the last loan record proof information of the loan record proof information table so as to finish the loan record proof information updating procedure of the loan procedure operation server R(O);

in which the loan record proof information of the loan record proof information table sequentially stores records in the loan record proof information table based on the set sequence of the loan record proof information and creates a loan record proof information sequence, and the loan procedure operation server R(O) deletes data stored in the updated loan record proof information register;

in which after the loan procedure processing server R(P) and the loan procedure operation server R(O) have finished the loan record proof information updating procedure respectively, the proof information updating procedure is finished;

in which contents of the loan record proof information table of the loan record proof information register of the loan procedure processing server R(P) and contents of the loan record proof information table of the loan record proof information register of the loan procedure operation server R(O) are the same as that of the loan record proof information table of the loan record proof information register of the loan procedure control server R(C) so as to simultaneously and synchronously update the loan file proof information table;

in which the user configured to connected to the intelligent loan procedure platform server W via the remote terminal T in order to click the loan procedure of the intelligent loan procedure of the finished data proof procedure which is set in the intelligent loan procedure platform server W;

in which the user is the loan procedure owner or the loan procedure participant of the loan procedure; and the loan procedure is the loan application procedure, the loan investigation procedure, the loan appraisal procedure, the loan agreement procedure, the loan setting procedure, or the loan approval procedure;

in which the intelligent loan procedure platform server W sends the loan procedure serial number of the loan procedure of the intelligent loan procedure of the finished data proof procedure to the intelligent loan procedure management server C;

in which the intelligent loan procedure management server C analyzes the loan procedure proof information index table based on the loan procedure serial number and verifies that the same stored in the loan procedure proof information index table has the same the proof information record storage data index code of the loan record storage data of the loan procedure serial number, and correspondingly stores same in the loan procedure data register having the same loan procedure serial number;

in which the intelligent loan procedure management server C sends the proof information record storage data index code of the loan record storage data to any of the loan procedure processing servers R(P) in a low operation storage work load via the intranet;

in which the loan procedure processing server R(P) accesses the corresponding loan record proof information stored in the loan record proof information table of the loan record proof information register based on the proof information serial number of the loan record proof information in the proof information record storage data index code of the loan record storage data, and analyzes same and verifies that the proof information sequence verification code of the loan record proof information is the same as the proof information sequence verification code of the loan record proof information in the proof information record storage data index code of the loan record storage data so as to confirm that the contents of the loan record proof information are not tampered with or changed;

in which the intelligent loan procedure management server C analyzes the loan procedure proof information index table based on the record storage data code of the loan record storage data in the proof information record storage data index code of the loan record storage data, and verifies that the same stored in the loan procedure proof information index table has the same proof information record storage data access code of the loan record storage data in the record storage data code of the loan record storage data;

in which the loan procedure processing server R(P) analyzes the loan procedure proof information index table based on the record storage data code of the loan record storage data in the proof information record storage data access code of the loan record storage data, and verifies that the same stored in the proof information record storage data storage address record table of the loan record proof information register has the same proof information record storage data access code of the loan record storage data in the proof information record storage data access code of the loan record storage data;

in which the loan procedure processing server R(P) accesses the loan record storage data stored in the proof information record storage data register based on the proof information record storage data storage address of the loan record storage data in the proof information record storage data access address of the loan record storage data, and decrypts the loan record storage data using a user's personal encryption and decryption data sequence so as to obtain the loan proof records and the proof information file storage data index code of the loan file storage data;

in which the loan record storage data is the loan application procedure record storage data, the loan investigation procedure record storage data, the loan appraisal procedure record storage data, the loan agreement procedure record storage data, the loan setting procedure record storage data, or the loan approval procedure record storage data;

in which the loan procedure processing server R(P) sends the loan proof records and the proof information file storage data index code of the loan file storage data to the intelligent loan procedure management server C based on the loan procedure serial number of the loan record storage data in the proof information record storage data index code of the loan record storage data, and stores the corresponding loan procedure data register store having the same loan procedure serial number;

in which the intelligent loan procedure management server C sends the proof information file storage data index code of the loan record storage data of the loan procedure data register to any of the loan data processing server F(P) in a low operation storage work load via the intranet;

in which the loan data processing server F(P) accesses the corresponding loan file proof information stored in the loan file proof information table of the loan file proof information register based on the proof information serial number of the loan file proof information in the proof information record storage data index code of the loan file storage data, and analyzes same and verifies that the proof information sequence verification code of the loan file proof information is the same as the proof information sequence verification code of the loan file proof information in the proof information record storage data index code of the loan file storage data so as to confirm that the contents of the loan file proof information are not tampered with or changed;

in which the loan data processing server F(P) analyzes the loan procedure proof information index table based on the record storage data code of the loan file storage data in the proof information record storage data index code of the loan file storage data, and verifies that the same stored in the loan procedure proof information index table has the same proof information record storage data access code of the loan file storage data in the record storage data code of the loan file storage data;

in which the loan data processing server F(P) analyzes the loan procedure proof information index table based on the proof information file storage data access code of the loan file storage data in the proof information record storage data index code of the loan file storage data, and verifies that the same stored in the proof information file storage data storage address record table of the loan file proof information register has the same proof information file storage data access code of the loan file storage data in the proof information file storage data access address of the loan file storage data;

in which the loan data processing server F(P) accesses the loan file storage data stored in the proof information file storage data register based on the proof information file storage data access address of the loan file storage data in the proof information file storage data access address of the loan file storage data, and decrypts the loan file storage data using a user's personal encryption and decryption data sequence so as to obtain the loan file division record table;

in which the loan file storage data is the loan application procedure file storage data, the loan investigation procedure file storage data, the loan appraisal procedure file storage data, the loan agreement procedure file storage data, the loan setting procedure file storage data, or the loan approval procedure file storage data;

in which the loan data processing server F(P) accesses the loan file division file stored in the loan file division file register of the loan data processing server F(P) based on the loan file division record of the loan file division record table so that the loan file division file is configured to convert to the loan proof file using a conversion procedure, and the loan data processing server F(P) uses the conversion procedure to obtain the corresponding loan proof file based on the loan file division record of the loan file division record table;

in which the loan data processing server F(P) sends the loan proof files to the intelligent loan procedure management server C based on the loan procedure serial number of the loan file storage data stored in the proof information file storage data index code of the loan file storage data, and stores the corresponding loan procedure data register having the same loan procedure serial number;

in which the intelligent loan procedure management server C sends the loan proof files of the loan procedure data register and the loan proof records to the intelligent loan procedure platform server W; and

in which the intelligent loan procedure platform server W sends the loan proof files of the loan procedure and the loan proof records to the remote terminal T by performing the intelligent loan procedure of the finished data proof procedure which has been clicked by the user so that the user can review or print the loan proof files of the loan procedure and the loan proof records.

While the invention has been described in terms of preferred embodiments, those skilled in the art will recognize that the invention can be practiced with modifications within the spirit and scope of the appended claims.

What is claimed is:

1. A method of intelligently verifying loan procedure implemented in a system of intelligently verifying loan procedure, the system of intelligently verifying loan procedure including an intelligent loan procedure platform system and an intelligent loan procedure management system, the intelligent loan procedure platform system including an intelligent loan procedure platform server (W) and a plurality of remote terminals (T), the intelligent loan procedure management system including an intelligent loan procedure management server (C), a plurality of loan data processing servers F(P), a loan data control server F(C), a plurality of loan data operation servers F(O), a plurality of loan procedure processing servers R(P), a loan procedure control server R(C) and a plurality of loan procedure operation servers R(O), the intelligent loan procedure platform server (W) connected to the internet and connected to the intelligent loan procedure management server (C) via an intranet wherein the remote terminals (T) configured to connected to the intelligent loan procedure platform server (W) via the internet, the intelligent loan procedure management server (C), the loan data processing servers F(P), the loan data control server F(C), the loan data operation servers F(O), the loan procedure processing servers R(P), the loan procedure control servers R(C) and the loan procedure operation servers R(O) interconnected via the intranet, the intelligent loan procedure management server C including a loan procedure proof information index table and a plurality of loan procedure data registers wherein the loan procedure data registers include a plurality of loan application procedure data registers, a plurality of loan investigation procedure data registers, a plurality of loan appraisal procedure data registers, a plurality of loan agreement procedure data registers, a plurality of loan setting procedure data registers and a plurality of loan approval procedure data registers, the loan data processing server F(P) including a loan file register, a loan file division file register, a loan file division record register, a loan file proof information register to be updated, a proof information file storage data register, and a loan file proof information register wherein the loan file proof information register includes a proof information file storage data storage address record table and a loan file proof information table, the loan file proof information table including a plurality of loan file proof information, the loan data control server F(C) including a loan file storage data register, an operation verification data register, a proof information file storage data register, and a loan file proof information register wherein the loan file proof information register includes a proof information file storage data storage address record table and a loan file proof information table, the loan file proof information table including a plurality of loan file proof information, the loan data operation server F(O) including a loan file proof information register to be updated, a proof information file storage data register, and a loan file proof information register wherein the loan file proof information register includes a proof information file storage data storage address record table and a loan file proof information table, the loan file proof information table including loan file proof information, the loan procedure processing server R(P) including a loan record register, a loan record proof information register to be updated, a proof information record storage data register, and a loan record proof information register wherein the loan record proof information register includes a proof information record storage data storage address record table and a loan record proof information table, the loan record proof information table including loan record proof information, the loan procedure control server R(C) including a loan record storage data register, an operation verification data register, a proof information record storage data register, and a loan record proof information register wherein the loan record proof information register includes a proof information record storage data storage address record table and a loan record proof information table, the loan record proof information table including loan record proof information, the loan procedure operation server R(O) including a loan record proof information register to be updated, a proof information record storage data register, and a loan record proof information register wherein the loan record proof information register includes a proof information record storage data storage address record table and a loan record proof information table, and the loan record proof information table includes loan record proof information, the method of intelligently verifying loan procedure comprising steps of:
enabling a user to connect to the intelligent loan procedure platform server (W) via the remote terminal and the internet, log in the intelligent loan procedure platform server (W) to verify a user name and a password, and obtain platform system member rights to for data communications;
enabling the user to enter a loan procedure via the intelligent loan procedure platform server (W) wherein the intelligent loan procedure platform server provides a user privilege share encoding and decoding data sequence and a personal encoding and decoding data sequence based on a non-symmetrical encoding and decoding algorithm wherein the user is a borrower, a relative of the borrower, a lawyer, a real estate agent, a loan agent, a secretary, an appraisal specialist, or a bank employee; and
enabling the user to set an intelligent loan procedure via the intelligent loan procedure platform server (W) so that the user becomes a loan procedure owner of an intelligent loan procedure;
wherein the intelligent loan procedure includes a plurality of loan procedures including a loan application procedure, a loan investigation procedure, a loan appraisal procedure, a loan agreement procedure, a loan setting procedure, and a loan approval procedure; and wherein the loan procedures of the intelligent loan procedure are performed sequentially;
wherein in performing one of the loan procedures of the intelligent loan procedure, the loan procedure owner sends a system confirmation notice of joining the loan procedure to another user via the intelligent loan procedure platform server (W) to invite another user to join the loan procedure, after another user's positive reply to the system confirmation notice of joining the loan procedure, another user becomes a loan procedure participant of the loan procedure wherein the loan procedure participant is allowed to only participate the invited loan procedure not other uninvited loan procedures;
wherein in performing the loan procedure, the loan procedure owner or the loan procedure participant uses a non-symmetrical encoding and decoding algorithm to encode or decode data to ensure loan data access privilege and data safety so that the loan procedure owner or the loan procedure participant uses a shared encoded data sequence to encode data and uses a shared decoded data sequence to decode data or a personal encoded data sequence to encode data and uses a personal decoded data sequence to decode data;
wherein the loan application procedure of the intelligent loan procedure uses the intelligent loan procedure platform server (W) to preset a plurality of loan files to be uploaded and a plurality of loan records to be loaded wherein the loan files to be uploaded include a loan application and a financial statement, the loan records to be uploaded include an application procedure text record and an application procedure loan information record;
wherein the loan investigation procedure uses the intelligent loan procedure platform server (W) to preset a plurality of loan files to be uploaded and a plurality of loan records to uploaded wherein the loan files to be uploaded includes a personal credit report, the loan records to be uploaded include an investigation procedure text record and an investigation procedure loan information record;
wherein the loan appraisal procedure uses the intelligent loan procedure platform server (W) to preset a plurality of loan files to be uploaded and a plurality of loan records to be uploaded wherein the loan files to be uploaded include a collateral appraisal report, the loan records to be uploaded include an appraisal procedure text record and an appraisal procedure loan information record;
wherein the loan agreement procedure uses the intelligent loan procedure platform server (W) to preset a plurality of loan files to be uploaded and a plurality of loan records to be uploaded wherein the loan files to be uploaded include a loan agreement, an identification document, a driver license, a license application, and a house certificate, the loan records to be uploaded include an agreement procedure text record and an agreement procedure loan information record;
wherein the loan setting procedure uses the intelligent loan procedure platform server (W) to preset a plurality of loan files to be uploaded and a plurality of loan records to be uploaded wherein the loan files to be uploaded include an asset security setting application and a house certificate, the loan records to be uploaded include a setting procedure text record and a setting procedure loan information record;
wherein the loan approval procedure uses the intelligent loan procedure platform server (W) to preset a plurality of loan files to be uploaded and a plurality of loan records to be uploaded wherein the loan files to be uploaded include a loan item transfer slip, the loan records to be uploaded include an approval procedure text record and an approval procedure loan information record;
wherein the loan procedure owner uses the intelligent loan procedure platform server (W) to add or delete the preset loan files to be uploaded in order to add or delete the loan file to be uploaded with respect to one of the loan procedures of the intelligent loan procedure, or add or delete the preset uploaded loan records to be uploaded in order to add or delete the loan records to be uploaded;
wherein in a process the loan application procedure of the intelligent loan procedure uploads the loan files to be uploaded or the loan records to be uploaded to the intelligent loan procedure platform server (W) via the loan procedure owner or the loan procedure participant of the loan application procedure, the intelligent loan procedure platform server (W) sends same to the loan application procedure data register set by the intelligent loan procedure management server (C) via the intranet, and stores the loan files to be uploaded as loan proof files or store the loan records to be uploaded as loan proof records;
wherein the loan application procedure uploads the loan files to be uploaded and the loan records to be uploaded to the loan application procedure data register of the intelligent loan procedure management server (C) and stores the corresponding loan proof files and the loan proof records, the loan procedure participant of the loan procedure owner or the loan application procedure checks the loan proof files and the loan proof records, and if it is correct the loan procedure participant of the loan procedure owner or the loan application procedure issues a confirmation notice of finishing the loan procedure;
wherein after all of the loan procedure participants and the loan procedure owners of the loan application procedure have issued the confirmation notice of finishing the loan procedure, the loan application procedure is finished; the intelligent loan procedure management server (C) sets a corresponding loan procedure serial number of the loan application procedure data register and sends the loan procedure serial number to the intelligent loan procedure platform server (W), the intelligent loan procedure platform server (W) sets the loan procedure serial number as a loan procedure serial number of the loan application procedure of the intelligent loan procedure; wherein in a process the loan investigation procedure of the intelligent loan procedure, the loan files to be uploaded or the loan records to be uploaded of the loan investigation procedure are sent to the intelligent loan procedure platform server (W) via the loan procedure participant of the loan procedure owner or the loan investigation procedure, the intelligent loan procedure platform server (W) sends same to the loan investigation procedure data register of the intelligent loan procedure management server (C) via the intranet, stores the loan files to be uploaded as loan proof files or stores the loan records to be uploaded as loan proof records;
wherein after the loan files to be uploaded and the loan records to be uploaded have been uploaded to the loan investigation procedure data register of the intelligent loan procedure management server (C), the loan investigation procedure stores them as the loan proof files and the loan proof records, the loan procedure owner or the loan procedure participant of the loan investigation procedure checks the loan proof files and the loan proof records, and if it is correct, the loan procedure owner or the loan procedure participant of the loan investigation procedure sends a confirmation notice of finishing the loan procedure, after all of the loan procedure participants and the loan procedure owners of the loan investigation procedure have sent the confirmation notice of finishing the loan procedure, the loan investigation procedure is finished, the intelligent loan procedure management server (C) sets a corresponding loan procedure serial number with respect to the loan investigation procedure data register, sends the loan procedure serial number to the intelligent loan procedure platform server (W), the intelligent loan procedure platform server (W) sends the loan procedure serial number as a loan procedure serial number of the loan investigation procedure of the intelligent loan procedure;
wherein in a process the loan appraisal procedure of the intelligent loan procedure uploads the loan files to be uploaded and the loan records to be uploaded to the intelligent loan procedure platform server (W) via the loan procedure owner or the loan procedure participant the loan appraisal procedure, the intelligent loan procedure platform server (W) sends same to the corresponding loan appraisal procedure data register of the intelligent loan procedure management server (C) via the intranet, and stores the loan files to be uploaded as loan proof files or stores the loan records to be uploaded as loan proof records;
wherein after the loan appraisal procedure has uploaded the loan files to be uploaded and the loan records to be uploaded to the loan appraisal procedure data register of the intelligent loan procedure management server (C) and has stored same as loan proof files and loan proof records, the loan procedure owner or the loan procedure participant of the loan appraisal procedure checks the loan proof files and the loan proof records, and if it is correct, the loan procedure owner or the loan procedure participant of the loan appraisal procedure issues a confirmation notice of finishing the loan procedure;
wherein after all of the loan procedure participants and the loan procedure owners of the loan appraisal procedure have sent the confirmation notice of finishing the loan procedure, the loan appraisal procedure is finished, the intelligent loan procedure management server (C) sets a corresponding loan procedure serial number with respect to the loan appraisal procedure data register and sends the loan procedure serial number to the intelligent loan procedure platform server (W), and the intelligent loan procedure platform server (W) sets the loan procedure serial number as a loan procedure serial number of the loan appraisal procedure of the intelligent loan procedure;
wherein in a process the loan agreement procedure of the intelligent loan procedure uploads the loan files to be uploaded or the loan records to be uploaded to the intelligent loan procedure platform server (W) via the loan procedure owner or the loan procedure participant of the loan agreement procedure, the intelligent loan procedure platform server (W) sends same to a corresponding loan agreement procedure data register of the intelligent loan procedure management server (C) via the intranet, and stores the loan files to be uploaded as loan proof files or stores the loan records to be uploaded as loan proof records;
wherein after the loan agreement procedure has uploaded the loan files to be uploaded and the loan records to be uploaded to the loan agreement procedure data register of the intelligent loan procedure management server (C) and has stored same as loan proof files and loan proof records, the loan procedure owner or the loan procedure participant of the loan agreement procedure checks the loan proof files and the loan proof records, and if it is correct, the loan procedure owner or the loan procedure participant of the loan agreement procedure issues a confirmation notice of finishing the loan procedure;
wherein after all of the loan procedure participants and the loan procedure owners of the loan agreement procedure have sent the confirmation notice of finishing the loan procedure, the loan agreement procedure is finished, the intelligent loan procedure management server (C) sets a corresponding loan procedure serial number with respect to the loan agreement procedure data register and sends the loan procedure serial number to the intelligent loan procedure platform server (W), and the intelligent loan procedure platform server (W) sets the loan procedure serial number as a loan procedure serial number of the loan agreement procedure of the intelligent loan procedure;
wherein in a process the loan setting procedure of the intelligent loan procedure uploads the loan files to be uploaded or the loan records to be uploaded to the intelligent loan procedure platform server (W) via the loan procedure owner or the loan procedure participant of the loan setting procedure, the intelligent loan procedure platform server (W) sends same to the corresponding loan setting procedure data register of the intelligent loan procedure management server (C) via the intranet, and stores the loan files to be uploaded as loan proof files or stores the loan records to be uploaded as loan proof records;
wherein after the loan setting procedure has uploaded the loan files to be uploaded and the loan records to be uploaded to the loan setting procedure data register of the intelligent loan procedure management server (C) and has stored same as loan proof files and loan proof records, the loan procedure owner or the loan procedure participant of the loan setting procedure checks the loan proof files and the loan proof records, and if it is correct, the loan procedure owner or the loan procedure participant of the loan setting procedure issues a confirmation notice of finishing the loan procedure;
wherein after all of the loan procedure participants and the loan procedure owners of the loan setting procedure have sent the confirmation notice of finishing the loan procedure, the loan setting procedure is finished, the intelligent loan procedure management server (C) sets a corresponding loan procedure serial number with respect to the loan setting procedure data register and sends the loan procedure serial number to the intelligent loan procedure platform server (W), and the intelligent loan procedure platform server (W) sets the loan procedure serial number as a loan procedure serial number of the loan setting procedure of the intelligent loan procedure;
wherein in a process the loan approval procedure of the intelligent loan procedure uploads the loan files to be uploaded or the loan records to be uploaded to the intelligent loan procedure platform server (W) via the loan procedure owner or the loan procedure participant of the loan approval procedure, the intelligent loan procedure platform server (W) sends same to the corresponding loan approval procedure data register of the intelligent loan procedure management server (C) via the intranet, and stores the loan files to be uploaded as loan proof files or stores the loan records to be uploaded as loan proof records;
wherein after the loan approval procedure has uploaded the loan files to be uploaded and the loan records to be uploaded to the loan approval procedure data register of the intelligent loan procedure management server (C) and has stored same as loan proof files and loan proof records, the loan procedure owner or the loan procedure participant of the loan approval procedure checks the loan proof files and the loan proof records, and if it is correct, the loan procedure owner or the loan procedure participant of the loan approval procedure issues a confirmation notice of finishing the loan procedure;
wherein after all of the loan procedure participants and the loan procedure owners of the loan approval procedure have sent the confirmation notice of finishing the loan procedure, the loan approval procedure is finished, the intelligent loan procedure management server (C) sets a corresponding loan procedure serial number with respect to the loan approval procedure data register and sends the loan procedure serial number to the intelligent loan procedure platform server (W), and the intelligent loan procedure platform server (W) sets the loan procedure serial number as a loan procedure serial number of the loan approval procedure of the intelligent loan procedure;
wherein the intelligent loan procedure management server (C) sends the loan procedure serial number of the loan application procedure data register and the loan proof files to any of the loan data processing servers F(P) in a low operation storage work load via the intranet and stores same in the loan file register;
wherein the loan data processing server F(P) performs a file division storage procedure on the loan proof files stored in the loan file register to divide the loan proof files into a plurality of loan files and stores same in the loan file division file register of each of other loan data processing servers F(P), and creates a corresponding loan file division record and stores same in the loan file division record register;
wherein after the loan data processing server F(P) has performed the file division storage procedure on the loan proof files stored in the loan file register, the loan data processing server F(P) creates a corresponding loan file division record table based on the loan file division record of the loan file division record register, the loan data processing server F(P) performs a file encryption storage procedure on the loan file division record table so that a shared encryption and decryption data sequence of the loan procedure owner and each loan procedure participant of the loan application procedure are used to perform a data encryption storage of the loan file division record table and create a corresponding loan application procedure file storage data, further sends same from the loan application procedure file storage data to the loan data control server F(C) via the intranet and stores same in the loan file storage data register wherein the loan data processing server F(P) sets a corresponding loan procedure serial number of the loan application procedure file storage data based on the loan procedure serial number of the loan application procedure data register, and the loan data processing server F(P) deletes data stored in both the loan file register and the loan file division record register;
wherein the intelligent loan procedure management server (C) sends the loan procedure serial number and the loan proof files of the loan investigation procedure data register to any of the loan data processing servers F(P) in a low operation storage work load via the intranet and stores same in the loan file register;
wherein the loan data processing server F(P) performs the file division storage procedure on the loan proof files stored in the loan file register to divide the loan proof files into a plurality of loan files and stores same in the loan file division file register of each of other loan data processing servers F(P), and creates a corresponding loan file division record and stores same in the loan file division record register;
wherein after the loan data processing server F(P) has performed the file division storage procedure on the loan proof files stored in the loan file register, the loan data processing server F(P) creates a corresponding loan file division record table based on the loan file division record of the loan file division record register, the loan data processing server F(P) performs the file encryption storage procedure on the loan file division record table so that the shared encryption and decryption data sequence of the loan procedure owner and each of the loan procedure participants of the loan investigation procedure are used to perform a data encryption storage of the loan file division record table, create a corresponding loan investigation procedure file storage data, send the loan investigation procedure file storage data to the loan data control server F(C) via the intranet, and store same in the loan file storage data register wherein the loan data processing server F(P) sets a corresponding loan procedure serial number of the loan investigation procedure file storage data based on the loan procedure serial number of the loan investigation procedure data register, and the loan data processing server F(P) deletes data stored in both the loan file register and the loan file division record register;
wherein the intelligent loan procedure management server (C) sends the loan procedure serial number of the loan appraisal procedure data register and the loan proof files to any of the loan data processing servers F(P) in a low operation storage work load via the intranet and stores same in the loan file register;
wherein the loan data processing server F(P) performs the file division storage procedure on the loan proof files stored in the loan file register to divide the loan proof files into a plurality of loan files and stores same in the loan file division file register of each of other loan data processing servers F(P), and creates a corresponding loan file division record and stores same in the loan file division record register;
wherein after the loan data processing server F(P) has performed the file division storage procedure on the loan proof files stored in the loan file register, the loan data processing server F(P) creates a corresponding loan file division record table based on the loan file division record of the loan file division record register, the loan data processing server F(P) performs a file encryption storage procedure on the loan file division record table so that a shared encryption and decryption data sequence of the loan procedure owner and each loan procedure participant of the loan application procedure are used to perform a data encryption storage of the loan file division record table and create a corresponding loan application procedure file storage data, further sends same from the loan application procedure file storage data to the loan data control server F(C) via the intranet and stores same in the loan file storage data register wherein the loan data processing server F(P) sets a corresponding loan procedure serial number of the loan application procedure file storage data based on the loan procedure serial number of the loan application procedure data register, and the loan data processing server F(P) deletes data stored in both the loan file register and the loan file division record register;
wherein the intelligent loan procedure management server (C) sends the loan procedure serial number of the loan appraisal procedure data register and the loan proof files to any of the loan data processing servers F(P) in a low operation storage work load via the intranet and stores same in the loan file register;
wherein the loan data processing server F(P) performs the file division storage procedure on the loan proof files stored in the loan file register to divide the loan proof files into a plurality of loan files and stores same in the loan file division file register of each of other loan data processing servers F(P), and creates a corresponding loan file division record and stores same in the loan file division record register;
wherein after the loan data processing server F(P) has performed the file division storage procedure on the loan proof files stored in the loan file register, the loan data processing server F(P) creates a corresponding loan file division record table based on the loan file division record of the loan file division record register, the loan data processing server F(P) performs the file encryption storage procedure on the loan file division record table so that the shared encryption and decryption data sequence of the loan procedure owner and each of the loan procedure participants of the loan investigation procedure are used to perform a data encryption storage of the loan file division record table, create a corresponding loan investigation procedure file storage data, send the loan investigation procedure file storage data to the loan data control server F(C) via the intranet, and store same in the loan file storage data register wherein the loan data processing server F(P) sets a corresponding loan procedure serial number of the loan investigation procedure file storage data based on the loan procedure serial number of the loan investigation procedure data register, and the loan data processing server F(P) deletes data stored in both the loan file register and the loan file division record register;
wherein the intelligent loan procedure management server (C) sends the loan procedure serial number of the loan appraisal procedure data register and the loan proof files to any of the loan data processing servers F(P) in a low operation storage work load via the intranet and stores same in the loan file register;
wherein the loan data processing server F(P) performs the file division storage procedure on the loan proof files stored in the loan file register to divide the loan proof files into a plurality of loan files and stores same in the loan file division file register of each of other loan data processing servers F(P), and creates a corresponding loan file division record and stores same in the loan file division record register;
wherein after the loan data processing server F(P) has performed the file division storage procedure on the loan proof files stored in the loan file register, the loan data processing server F(P) creates a corresponding loan file division record table based on the loan file division record of the loan file division record register, the loan data processing server F(P) performs the file encryption storage procedure on the loan file division record table so that the shared encryption and decryption data sequence of the loan procedure owner and each of the loan procedure participants of the loan setting procedure are used to perform a data encryption storage of the loan file division record table, create a corresponding loan setting procedure file storage data, send the loan setting procedure file storage data to the loan data control server F(C) via the intranet, and store same in the loan file storage data register wherein the loan data processing server F(P) sets a corresponding loan procedure serial number of the loan setting procedure file storage data based on the loan procedure serial number of the loan setting procedure data register, and the loan data processing server F(P) deletes data stored in both the loan file register and the loan file division record register;
wherein the intelligent loan procedure management server (C) sends the loan procedure serial number of the loan approval procedure data register and the loan proof files to any of the loan data processing servers F(P) in a low operation storage work load via the intranet and stores same in the loan file register;
wherein the loan data processing server F(P) performs the file division storage procedure on the loan proof files stored in the loan file register to divide the loan proof files into a plurality of loan files and stores same in the loan file division file register of each of other loan data processing servers F(P), and creates a corresponding loan file division record and stores same in the loan file division record register;
wherein after the loan data processing server F(P) has performed the file division storage procedure on the loan proof files stored in the loan file register, the loan data processing server F(P) creates a corresponding loan file division record table based on the loan file division record of the loan file division record register, the loan data processing server F(P) performs the file encryption storage procedure on the loan file division record table so that the shared encryption and decryption data sequence of the loan procedure owner and each of the loan procedure participants of the loan approval procedure are used to perform a data encryption storage of the loan file division record table, create a corresponding loan approval procedure file storage data, send the loan approval procedure file storage data to the loan data control server F(C) via the intranet, and store same in the loan file storage data register;
wherein the loan data processing server F(P) sets a corresponding loan procedure serial number of the loan approval procedure file storage data based on the loan procedure serial number of the loan approval procedure data register, and the loan data processing server F(P) deletes data stored in both the loan file register and the loan file division record register;
wherein the loan file storage data register of the loan data control server F(C) stores loan file storage data wherein the loan file storage data is the loan application procedure file storage data, the loan investigation procedure file storage data, the loan appraisal procedure file storage data, the loan agreement procedure file storage data, the loan setting procedure file storage data or the loan approval procedure file storage data;
wherein the loan data control server F(C) sequentially accesses the loan file storage data stored in the loan file storage data register based on operation execution sequence of data operation verification period operation of the system and operation data and stores same in the operation verification data register, and in the data operation verification period, the loan data control server F(C) sequentially performs a storage data operation verification procedure, an added proof information procedure, and an updated proof information procedure on the loan file storage data stored in the operation verification data register;
wherein the storage data operation verification procedure includes a first storage data operation verification procedure, a second storage data operation verification procedure, and a third storage data operation verification procedure;
wherein the first storage data operation verification procedure including the loan data control server F(C) sends the loan file storage data of the operation verification data register to the loan data operation server F(O), the loan data operation server F(O) performs a data encryption operation on the loan file storage data based on a system setting data encryption algorithm, and sends a value of the completed encryption operation to the loan data control server F(C);
wherein the loan data control server F(C) analyzes same and verifies that at least 50% of the value of the encryption operation is the same, the loan data control server F(C) correspondingly sets the value of the encryption operation as a file storage data operation code of the loan file storage data so as to finish an encoding procedure of the storage data of the loan file storage data;
wherein the loan data control server F(C) activates the loan data operation server F(O) to finish the storage data encoding procedure of the loan file storage data of the operation verification data register so as to set a corresponding file storage data operation code of the loan file storage data;
wherein the second storage data operation verification procedure including the loan data control server F(C) sends the file storage data operation code of the loan file storage data to the loan data operation server F(O), the loan data operation server F(O) performs a data encryption operation on the loan file storage data based on a system setting data encryption algorithm, and sends a value of the completed encryption operation to the loan data control server F(C);
wherein the loan data control server F(C) analyzes same and verifies that at least 50% of the value of the encryption operation is the same, the loan data control server F(C) correspondingly sets the value of the encryption operation as a file storage data code of the loan file storage data so as to finish an encoding procedure of the storage data of the loan file storage data;
wherein the third storage data operation verification procedure including the loan data control server F(C) sends the file storage data code and the file storage data operation code of the loan file storage data to the loan data operation server F(O), the loan data operation server F(O) performs a data encryption operation on the loan file storage data based on a system setting data encryption algorithm, and sends a value of the completed encryption operation to the loan data control server F(C);
wherein the loan data control server F(C) analyzes same and verifies that at least 50% of the value of the encryption operation is the same, the loan data control server F(C) correspondingly sets the value of the encryption operation as a proof information file storage data access code of the loan file storage data so as to finish a proof information encoding procedure of the loan file storage data;
wherein the loan data control server F(C) activates the loan data operation server F(O) to finish the proof information encoding procedure of the loan file storage data of the operation verification data register so as to set a corresponding proof information file storage data access code of the loan file storage data;
wherein the added proof information procedure includes a first added proof information procedure, a second added proof information procedure, a third added proof information procedure, a fourth added proof information procedure, and a fifth added proof information procedure;
wherein the first added proof information procedure including the loan data control server F(C) stores the loan file storage data of the operation verification data register in the proof information file storage data register, sets a corresponding storage address as a proof information file storage data storage address of the loan file storage data, uses the proof information file storage data access code of the loan file storage data and the proof information file storage data storage address to set a proof information file storage data access address of the loan file storage data so as to finish the proof information storage record procedure of the loan file storage data;
wherein after the loan data control server F(C) has finished the proof information storage record procedure of the loan file storage data of the operation verification data register, the loan data control server F(C) sets a corresponding proof information file storage data access address of the loan file storage data, and uses the proof information file storage data access address of the loan file storage data to create a storage record in the proof information file storage data storage address record table of the loan file proof information register;
wherein the second added proof information procedure including the loan data control server F(C) sets the file storage data operation code of the loan file storage data and the proof information file storage data access code as a proof information file storage data access code of the loan file storage data to finish the proof information access code encoding procedure of the loan file storage data;
wherein after the loan data control server F(C) has finished the proof information access code encoding procedure of the loan file storage data of the operation verification data register, the loan data control server F(C) sets a corresponding proof information file storage data access code of the loan file storage data;
wherein the third added proof information procedure including the loan data control server F(C) sequentially sets a proof information serial number of the loan file proof information based on a serial number of a storage record in the loan file proof information of the loan file proof information table of the loan file proof information register, and sets an information verification code of the last loan file proof information of the loan file proof information table as a proof information sequence verification code of the loan file proof information, and sets the file storage data code as an information verification code of the loan file proof information;
wherein the fourth added proof information procedure including the loan data control server F(C) sets the proof information serial number of the loan file proof information, the proof information sequence verification code, the information verification code, and the proof information file storage data access code of the loan file storage data as contents of the loan file proof information, and stores same in the loan file proof information table, and the loan file proof information is the last loan file proof information of the loan file proof information table;
wherein the loan file proof information of the loan file proof information table sequentially stores a record in the loan file proof information table based on the set sequence of the loan file proof information, and creates a loan file proof information sequence;
wherein the fifth added proof information procedure including the loan data control server F(C) sets the loan procedure serial number of the loan file storage data, the proof information serial number of the loan file proof information, the proof information sequence verification code, and the file storage data operation code of the loan file storage data as a proof information file storage data index code of the loan file storage data to finish proof information index encoding procedure of the loan file storage data;
wherein after the loan data control server F(C) has finished the loan file storage data of the proof information index encoding procedure of the operation verification data register, the loan data control server F(C) sets a corresponding proof information file storage data index code of the loan file storage data, and sends the proof information file storage data index code of the loan file storage data to the intelligent loan procedure management server (C) via the intranet;
wherein the intelligent loan procedure management server (C) analyzes the loan procedure serial number of the loan file storage data of the proof information file storage data index code based on the loan file storage data to verify that the loan procedure data register has same loan procedure serial number, stores the proof information file storage data index code of the loan file storage data in the loan procedure data register, and stores the proof information file storage data index code of the loan file storage data in the corresponding loan procedure data register;
wherein the loan procedure data register is the loan application procedure data register, the loan investigation procedure data register, the loan appraisal procedure data register, the loan agreement procedure data register, the loan setting procedure data register, or the loan approval procedure data register;
wherein the updated proof information procedure includes a first updated proof information procedure and a second updated proof information procedure;
wherein the first updated proof information procedure including the loan data control server F(C) sends the loan file storage data of the operation verification data register, the proof information file storage data access code of the loan file storage data, and the loan file proof information to the loan data processing server F(P) via the intranet, and stores same in both the updated loan file proof information register of the loan data processing server F(P) and the updated loan file proof information register of the loan data operation server F(O); and the loan data control server F(C) deletes data stored in the operation verification data register;
wherein the second updated proof information procedure including the loan data processing server F(P) stores the loan file storage data of the updated loan file proof information register in the proof information file storage data register, sets a corresponding storage address as a proof information file storage data storage address of the loan file storage data, sets the proof information file storage data access code of the loan file storage data and the proof information file storage data storage address as a proof information file storage data access address of the loan file storage data, and finishes proof information storage record procedure of the loan file storage data;
wherein after the loan data processing server F(P) has finished the proof information storage record procedure of the loan file storage data of the updated loan file proof information register, the loan data processing server F(P) sets a corresponding proof information file storage data access address of the loan file storage data;
wherein the loan data processing server F(P) stores the proof information file storage data access address of the loan file storage data in the proof information file storage data storage address record table of the loan file proof information register;
wherein the loan data processing server F(P) sets the loan file proof information of the updated loan file proof information register in the loan file proof information table of the loan file proof information register, the loan file proof information is the last loan file proof information of the loan file proof information table, and finishes the loan file proof information updating procedure;
wherein the loan file proof information of the loan file proof information table is sequentially stored in the loan file proof information table based on the set sequence of the loan file proof information, creates a loan file proof information sequence, and the loan data processing server F(P) deletes data stored in the updated loan file proof information register;
wherein the loan data operation server F(O) stores the loan file storage data of the updated loan file proof information register in the proof information file storage data register, sets a corresponding storage address as a proof information file storage data storage address of the loan file storage data, sets the proof information file storage data access code of the loan file storage data and the proof information file storage data storage address as a proof information file storage data access address of the loan file storage data, and finishes the proof information storage record procedure of the loan file storage data;
wherein after the loan data operation server F(O) has finished the loan file storage data of the proof information storage record procedure of the updated loan file proof information register, the loan data operation server F(O) sets a corresponding proof information file storage data access address of the loan file storage data, and stores the proof information file storage data access address of the loan file storage data in the proof information file storage data storage address record table of the loan file proof information register;
wherein the loan data operation server F(O) sets the loan file proof information of the updated loan file proof information register in the loan file proof information table of the loan file proof information register, the loan file proof information is the last loan file proof information of the loan file proof information table, and finishes the loan file proof information updating procedure;
wherein the loan file proof information of the loan file proof information table is sequentially stored in the loan file proof information table based on the set sequence of the loan file proof information, creates a loan file proof information sequence, and the loan data processing server F(P) deletes data stored in the updated loan file proof information register;
wherein after the loan data processing server F(P) and the loan data operation server F(O) has finished the loan file proof information updating procedure respectively, the proof information procedure is updated;
wherein contents of the loan file proof information table of the loan file proof information register of the loan data processing server F(P) and contents of the loan file proof information table of the loan file proof information register of the loan data operation server F(O) are the same as that of the loan file proof information table of the loan file proof information register of the loan data control server F(C) so as to simultaneously and synchronously update the loan file proof information table;
wherein the intelligent loan procedure management server (C) sends the loan procedure serial number of the loan application procedure data register, the loan proof records and the proof information file storage data index code of the loan application procedure file storage data to any of the loan procedure data processing servers R(P) in a low operation storage work load via the intranet and stores same in the loan record register;
wherein the loan procedure processing server R(P) performs a record encryption storage procedure on the loan proof records of the loan record register and the proof information file storage data index code of the loan application procedure file storage data so that a shared encryption and decryption data sequence of the loan procedure owner and each loan procedure participant of the loan application procedure are used to perform a data encryption storage of the loan proof records and the proof information file storage data index code of the loan application procedure file storage data and create a corresponding loan application procedure record storage data; and further sends same from the loan application procedure record storage data to the loan data control server R(C) via the intranet and stores same in the loan record storage data register;
wherein the loan procedure processing server R(P) sets a corresponding loan procedure serial number of the loan application procedure record storage data based on the loan procedure serial number of the loan application procedure data register, and the loan procedure processing server R(P) deletes data stored in the loan record register;
wherein the intelligent loan procedure management server (C) sends the loan procedure serial number of the loan investigation procedure data register, the loan proof records and the proof information file storage data index code of the loan investigation procedure file storage data to any of the loan procedure data processing servers R(P) in a low operation storage work load via the intranet and stores same in the loan record register;
wherein the loan procedure processing server R(P) performs a record encryption storage procedure on the loan proof records of the loan record register and the proof information file storage data index code of the loan investigation procedure file storage data so that a shared encryption and decryption data sequence of the loan procedure owner and each loan procedure participant of the loan application procedure are used to perform a data encryption storage of the loan proof records and the proof information file storage data index code of the loan investigation procedure file storage data and create a corresponding loan investigation procedure record storage data; and further sends same from the loan investigation procedure record storage data to the loan data control server R(C) via the intranet and stores same in the loan record storage data register;
wherein the loan procedure processing server R(P) sets a corresponding loan procedure serial number of the loan investigation procedure record storage data based on the loan procedure serial number of the loan investigation procedure data register, and the loan procedure processing server R(P) deletes data stored in the loan record register;
wherein the intelligent loan procedure management server (C) sends the loan procedure serial number of the loan appraisal procedure data register, the loan proof records and the proof information file storage data index code of the loan appraisal procedure file storage data to any of the loan procedure data processing servers R(P) in a low operation storage work load via the intranet and stores same in the loan record register;
wherein the loan procedure processing server R(P) performs a record encryption storage procedure on the loan proof records of the loan record register and the proof information file storage data index code of the loan appraisal procedure file storage data so that a shared encryption and decryption data sequence of the loan procedure owner and each loan procedure participant of the loan appraisal procedure are used to perform a data encryption storage of the loan proof records and the proof information file storage data index code of the loan appraisal procedure file storage data and create a corresponding loan appraisal procedure record storage data; and further sends same from the loan appraisal procedure record storage data to the loan data control server R(C) via the intranet and stores same in the loan record storage data register;
wherein the loan procedure processing server R(P) sets a corresponding loan procedure serial number of the loan appraisal procedure record storage data based on the loan procedure serial number of the loan appraisal procedure data register, and the loan procedure processing server R(P) deletes data stored in the loan record register;
wherein the intelligent loan procedure management server (C) sends the loan procedure serial number of the loan agreement procedure data register, the loan proof records and the proof information file storage data index code of the loan agreement procedure file storage data to any of the loan procedure data processing servers R(P) in a low operation storage work load via the intranet and stores same in the loan record register;
wherein the loan procedure processing server R(P) performs a record encryption storage procedure on the loan proof records of the loan record register and the proof information file storage data index code of the loan agreement procedure file storage data so that a shared encryption and decryption data sequence of the loan procedure owner and each loan procedure participant of the loan agreement procedure are used to perform a data encryption storage of the loan proof records and the proof information file storage data index code of the loan agreement procedure file storage data and create a corresponding loan agreement procedure record storage data; and further sends same from the loan agreement procedure record storage data to the loan data control server R(C) via the intranet and stores same in the loan record storage data register;
wherein the loan procedure processing server R(P) sets a corresponding loan procedure serial number of the loan agreement procedure record storage data based on the loan procedure serial number of the loan agreement procedure data register, and the loan procedure processing server R(P) deletes data stored in the loan record register;
wherein the intelligent loan procedure management server (C) sends the loan procedure serial number of the loan setting procedure data register, the loan proof records and the proof information file storage data index code of the loan setting procedure file storage data to any of the loan procedure data processing servers R(P) in a low operation storage work load via the intranet and stores same in the loan record register;
wherein the loan procedure processing server R(P) performs a record encryption storage procedure on the loan proof records of the loan record register and the proof information file storage data index code of the loan setting procedure file storage data so that a shared encryption and decryption data sequence of the loan procedure owner and each loan procedure participant of the loan setting procedure are used to perform a data encryption storage of the loan proof records and the proof information file storage data index code of the loan setting procedure file storage data and create a corresponding loan setting procedure record storage data; and further sends same from the loan setting procedure record storage data to the loan data control server R(C) via the intranet and stores same in the loan record storage data register;
wherein the loan procedure processing server R(P) sets a corresponding loan procedure serial number of the loan setting procedure record storage data based on the loan procedure serial number of the loan setting procedure data register, and the loan procedure processing server R(P) deletes data stored in the loan record register; wherein the intelligent loan procedure management server (C) sends the loan procedure serial number of the loan approval procedure data register, the loan proof records and the proof information file storage data index code of the loan approval procedure file storage data to any of the loan procedure data processing servers R(P) in a low operation storage work load via the intranet and stores same in the loan record register;
wherein the loan procedure processing server R(P) performs a record encryption storage procedure on the loan proof records of the loan record register and the proof information file storage data index code of the loan approval procedure file storage data so that a shared encryption and decryption data sequence of the loan procedure owner and each loan procedure participant of the loan approval procedure are used to perform a data encryption storage of the loan proof records and the proof information file storage data index code of the loan approval procedure file storage data and create a corresponding loan approval procedure record storage data; and further sends same from the loan approval procedure record storage data to the loan data control server R(C) via the intranet and stores same in the loan record storage data register;
wherein the loan procedure processing server R(P) sets a corresponding loan procedure serial number of the loan approval procedure record storage data based on the loan procedure serial number of the loan approval procedure data register, and the loan procedure processing server R(P) deletes data stored in the loan record register;
wherein the loan record storage data register of the loan procedure control server R(C) stores a plurality of loan record storage data wherein the loan record storage data is the loan application procedure record storage data, the loan investigation procedure record storage data, the loan appraisal procedure record storage data, the loan agreement procedure record storage data, the loan setting procedure record storage data, or the loan approval procedure record storage data;
wherein the loan procedure control server R(C) sequentially accesses the loan file storage data stored in the loan record storage data register based on operation execution sequence of data operation verification period operation of the system and operation data and stores same in the operation verification data register, and in the data operation verification period, the loan procedure control server R(C) sequentially performs a storage data operation verification procedure, an added proof information procedure, and an updated proof information procedure on the loan record storage data stored in the operation verification data register;
wherein the storage data operation verification procedure includes a first storage data operation verification procedure, a second storage data operation verification procedure, and a third storage data operation verification procedure;
wherein the first storage data operation verification procedure including the loan procedure control server R(C) sends the loan record storage data of the operation verification data register to the loan data operation server R(O), the loan data operation server R(O) performs a data encryption operation on the loan record storage data based on a system setting data encryption algorithm, and sends a value of the completed encryption operation to the loan data control server R(C);
wherein the loan data control server R(C) analyzes same and verifies that at least 50% of the value of the encryption operation is the same, the loan data control server R(C) correspondingly sets the value of the encryption operation as a record storage data operation code of the loan record storage data so as to finish an encoding procedure of the storage data of the loan record storage data;
wherein the loan data control server R(C) activates the loan data operation server R(O) to finish the proof information encoding procedure of the loan record storage data of the operation verification data register so as to set a corresponding proof information record storage data access code of the loan record storage data;
wherein the second storage data operation verification procedure including the loan procedure control server R(C) sends the record storage data operation code of the loan record storage data to the loan data operation server R(O), the loan data operation server R(O) performs a data encryption operation on the loan record storage data based on a system setting data encryption algorithm, and sends a value of the completed encryption operation to the loan data control server R(C);
wherein the loan data control server R(C) analyzes same and verifies that at least 50% of the value of the encryption operation is the same, the loan data control server R(C) correspondingly sets the value of the encryption operation as a record storage data operation code of the loan record storage data;
wherein the third storage data operation verification procedure including the loan procedure control server R(C) sends the file storage data code and the file storage data operation code of the loan file storage data to the loan data operation server R(O), the loan data operation server R(O) performs a data encryption operation on the loan file storage data based on a system setting data encryption algorithm, and sends a value of the completed encryption operation to the loan data control server R(C);
wherein the loan data control server R(C) analyzes same and verifies that at least 50% of the value of the encryption operation is the same, the loan data control server R(C) correspondingly sets the value of the encryption operation as a proof information file storage data access code of the loan file storage data so as to finish a proof information encoding procedure of the loan file storage data;
wherein the loan data control server R(C) activates the loan data operation server R(O) to finish the proof information encoding procedure of the loan file storage data of the operation verification data register so as to set a corresponding proof information file storage data access code of the loan file storage data;
wherein the loan procedure control server R(C) analyzes same and verifies that at least 50% of the value of the encryption operation is the same, the loan data control server R(C) correspondingly sets the value of the encryption operation as a proof information file storage data access code of the loan record storage data so as to finish a proof information encoding procedure of the loan record storage data;
wherein the loan data control server R(C) activates the loan data operation server R(O) to finish the proof information encoding procedure of the loan record storage data of the operation verification data register so as to set a corresponding proof information file storage data access code of the loan record storage data;
wherein the added proof information procedure includes a first added proof information procedure, a second added proof information procedure, a third added proof information procedure, a fourth added proof information procedure, and a fifth added proof information procedure;
wherein the first added proof information procedure including the loan procedure control server R(C) stores the loan record storage data of the operation verification data register in the proof information record storage data register, sets a corresponding storage address as the proof information record storage data storage address of the loan record storage data, and sets the proof information record storage data access code of the loan record storage data and the proof information record storage data storage address as a proof information record storage data access address of the loan record storage data so as to finish the proof information storage record procedure of the loan record storage data;
wherein after the loan procedure control server R(C) has finished the proof information storage record procedure of the loan record storage data of the operation verification data register, the loan procedure control server R(C) sets a corresponding proof information record storage data access address of the loan record storage data; wherein the loan procedure control server R(C) stores the proof information record storage data access address of the loan record storage data in the proof information record storage data storage address record table of the loan record proof information register;
wherein the second added proof information procedure including the loan procedure control server R(C) sets the record storage data code of the loan record storage data and the proof information record storage data access code as a proof information record storage data access code of the loan record storage data to finish the proof information access code encoding procedure of the loan record storage data;
wherein after the loan procedure control server R(C) has finished the proof information access code encoding procedure of the loan record storage data of the operation verification data register, the loan procedure control server R(C) sets a corresponding proof information record storage data access code of the loan record storage data;
wherein the third added proof information procedure including the loan procedure control server R(C) sequentially sets a proof information serial number of the added loan record proof information based on a serial number of the loan record proof information stored in the loan record proof information table of the loan record proof information register, sets the information verification code of the last loan record proof information of the loan record proof information table as a proof information sequence verification code of the added loan record proof information, and sets the record storage data code as an information verification code of the added loan record proof information;
wherein the fourth added proof information procedure including the loan procedure control server R(C) sets the proof information serial number of the added loan record proof information, the proof information sequence verification code, the information verification code, and the proof information record storage data access code of the loan record storage data as contents of the added loan record proof information and stores same in the loan record proof information table, and the added loan record proof information is the last loan record proof information of the loan record proof information table;
wherein the loan record proof information of the loan record proof information table sequentially stores records in the loan record proof information table based on the set sequence of the loan record proof information, and creates a loan record proof information sequence;
wherein the fifth added proof information procedure including the loan procedure control server R(C) sets the loan procedure serial number of the loan record storage data, the proof information serial number of the added loan record proof information, the proof information sequence verification code, and the record storage data code of the loan record storage data as a proof information record storage data index code of the loan record storage data so as to finish the proof information index encoding procedure of the loan record storage data;
wherein after the loan procedure control server R(C) has finished the proof information index encoding procedure of the loan record storage data of the operation verification data register, the loan procedure control server R(C) sets a corresponding proof information record storage data index code of the loan record storage data, the loan procedure control server R(C) sends the proof information record storage data index code of the loan record storage data to the intelligent loan procedure management server (C) via the intranet, and stores same in the loan procedure proof information index table;
wherein the intelligent loan procedure management server (C) analyzes the loan procedure serial number of the loan record storage data of the proof information record storage data index code based on the added loan record storage data in the loan procedure proof information index table and verifies that the loan procedure data register has the same loan procedure serial number, deletes data stored in the loan procedure data register, and sends the loan procedure serial number of the loan record storage data stored in the proof information record storage data index code of the added loan record storage data to the intelligent loan procedure platform server (W);
wherein the intelligent loan procedure platform server (W) analyzes the loan procedure serial number of the loan record storage data of the proof information record storage data index code based on the loan procedure serial number and verifies that the loan procedure of the intelligent loan procedure has the same loan procedure serial number, and sets the loan procedure as a finished data proof procedure;
wherein the loan procedure is the loan application procedure, the loan investigation procedure, the loan appraisal procedure, the loan agreement procedure, the loan setting procedure, or the loan approval procedure;
wherein the update proof information procedure includes a first updated proof information procedure and a second updated proof information procedure;
wherein the first updated proof information procedure including the loan procedure control server R(C) sends the loan record storage data of the operation verification data register and the loan record proof information of the proof information record storage data access code of the loan record storage data via the intranet and stores same in the updated loan record proof information register of the loan procedure processing server R(P) and the updated loan record proof information register of the loan procedure operation server R(O), and the loan procedure control server R(C) deletes data stored in the operation verification data register;
wherein the second updated proof information procedure including the loan procedure processing server R(P) stores the loan record storage data of the updated loan record proof information register in the proof information record storage data register, sets a corresponding storage address as a proof information record storage data storage address of the loan record storage data, sets the proof information record storage data access code of the loan record storage data and the proof information record storage data storage address as a proof information record storage data access address of the loan record storage data, and finishes the proof information storage record procedure of the loan record storage data;
wherein after the loan procedure processing server R(P) has finished the proof information storage record procedure of the loan record storage data of the updated loan record proof information register, the loan procedure processing server R(P) sets a corresponding proof information record storage data access address of the loan record storage data;
wherein the loan procedure processing server R(P) stores the proof information record storage data access address of the loan record storage data in the proof information record storage data storage address record table of the loan record proof information register, the loan procedure processing server R(P) sets the added loan record proof information of the updated loan record proof information register in the loan record proof information table of the loan record proof information register, and the added loan record proof information is the last loan record proof information of the loan record proof information table so as to finish the loan record proof information updating procedure of the loan procedure processing server R(P);
wherein the loan record proof information of the loan record proof information table sequentially stores records in the loan record proof information table based on the set sequence of the loan record proof information and creates a loan record proof information sequence, and the loan procedure processing server R(P) deletes data stored in the updated loan record proof information register;
wherein the loan procedure operation server R(O) stores the loan record storage data of the updated loan record proof information register in the proof information record storage data register and sets the corresponding storage address as a proof information record storage data storage address of the loan record storage data, and sets the proof information record storage data access code of the loan record storage data and the proof information record storage data storage address as a the proof information record storage data access address of the loan record storage data so as to finish the proof information storage record procedure of the loan record storage data;
wherein after the loan procedure operation server R(O) has finished the proof information storage record procedure of the loan record storage data of the updated loan record proof information register, the loan procedure operation server R(O) sets a corresponding proof information record storage data access address of the loan record storage data, the loan procedure operation server R(O) stores the proof information record storage data access address of the loan record storage data in the proof information record storage data storage address record table of the loan record proof information register, the loan procedure operation server R(O) sets the added loan record proof information of the updated loan record proof information register in the loan record proof information table of the loan record proof information register, and the added loan record proof information is the last loan record proof information of the loan record proof information table so as to finish the loan record proof information updating procedure of the loan procedure operation server R(O);
wherein the loan record proof information of the loan record proof information table sequentially stores records in the loan record proof information table based on the set sequence of the loan record proof information and creates a loan record proof information sequence, and the loan procedure operation server R(O) deletes data stored in the updated loan record proof information register;
wherein after the loan procedure processing server R(P) and the loan procedure operation server R(O) have finished the loan record proof information updating procedure respectively, the proof information updating procedure is finished;
wherein contents of the loan record proof information table of the loan record proof information register of the loan procedure processing server R(P) and contents of the loan record proof information table of the loan record proof information register of the loan procedure operation server R(O) are the same as that of the loan record proof information table of the loan record proof information register of the loan procedure control server R(C) so as to simultaneously and synchronously update the loan file proof information table;
wherein the user configured to connected to the intelligent loan procedure platform server (W) via the remote terminal T in order to click the loan procedure of the intelligent loan procedure of the finished data proof procedure which is set in the intelligent loan procedure platform server (W);
wherein the user is the loan procedure owner or the loan procedure participant of the loan procedure; and the loan procedure is the loan application procedure, the loan investigation procedure, the loan appraisal procedure, the loan agreement procedure, the loan setting procedure, or the loan approval procedure;
wherein the intelligent loan procedure platform server (W) sends the loan procedure serial number of the loan procedure of the intelligent loan procedure of the finished data proof procedure to the intelligent loan procedure management server (C);
wherein the intelligent loan procedure management server (C) analyzes the loan procedure proof information index table based on the loan procedure serial number and verifies that the same stored in the loan procedure proof information index table has the same the proof information record storage data index code of the loan record storage data of the loan procedure serial number, and correspondingly stores same in the loan procedure data register having the same loan procedure serial number;
wherein the intelligent loan procedure management server (C) sends the proof information record storage data index code of the loan record storage data to any of the loan procedure processing servers R(P) in a low operation storage work load via the intranet;
wherein the loan procedure processing server R(P) accesses the corresponding loan record proof information stored in the loan record proof information table of the loan record proof information register based on the proof information serial number of the loan record proof information in the proof information record storage data index code of the loan record storage data, and analyzes same and verifies that the proof information sequence verification code of the loan record proof information is the same as the proof information sequence verification code of the loan record proof information in the proof information record storage data index code of the loan record storage data so as to confirm that the contents of the loan record proof information are not tampered with or changed;
wherein the intelligent loan procedure management server (C) analyzes the loan procedure proof information index table based on the record storage data code of the loan record storage data in the proof information record storage data index code of the loan record storage data, and verifies that the same stored in the loan procedure proof information index table has the same proof information record storage data access code of the loan record storage data in the record storage data code of the loan record storage data;
wherein the loan procedure processing server R(P) analyzes the loan procedure proof information index table based on the record storage data code of the loan record storage data in the proof information record storage data access code of the loan record storage data, and verifies that the same stored in the proof information record storage data storage address record table of the loan record proof information register has the same proof information record storage data access code of the loan record storage data in the proof information record storage data access code of the loan record storage data;
wherein the loan procedure processing server R(P) accesses the loan record storage data stored in the proof information record storage data register based on the proof information record storage data storage address of the loan record storage data in the proof information record storage data access address of the loan record storage data, and decrypts the loan record storage data using a user's personal encryption and decryption data sequence so as to obtain the loan proof records and the proof information file storage data index code of the loan file storage data;
wherein the loan record storage data is the loan application procedure record storage data, the loan investigation procedure record storage data, the loan appraisal procedure record storage data, the loan agreement procedure record storage data, the loan setting procedure record storage data, or the loan approval procedure record storage data;
wherein the loan procedure processing server R(P) sends the loan proof records and the proof information file storage data index code of the loan file storage data to the intelligent loan procedure management server (C) based on the loan procedure serial number of the loan record storage data in the proof information record storage data index code of the loan record storage data, and stores the corresponding loan procedure data register store having the same loan procedure serial number;
wherein the intelligent loan procedure management server (C) sends the proof information file storage data index code of the loan record storage data of the loan procedure data register to any of the loan data processing server F(P) in a low operation storage work load via the intranet;
wherein the loan data processing server F(P) accesses the corresponding loan file proof information stored in the loan file proof information table of the loan file proof information register based on the proof information serial number of the loan file proof information in the proof information record storage data index code of the loan file storage data, and analyzes same and verifies that the proof information sequence verification code of the loan file proof information is the same as the proof information sequence verification code of the loan file proof information in the proof information record storage data index code of the loan file storage data so as to confirm that the contents of the loan file proof information are not tampered with or changed;
wherein the loan data processing server F(P) analyzes the loan procedure proof information index table based on the record storage data code of the loan file storage data in the proof information record storage data index code of the loan file storage data, and verifies that the same stored in the loan procedure proof information index table has the same proof information record storage data access code of the loan file storage data in the record storage data code of the loan file storage data;
wherein the loan data processing server F(P) analyzes the loan procedure proof information index table based on the proof information file storage data access code of the loan file storage data in the proof information record storage data index code of the loan file storage data, and verifies that the same stored in the proof information file storage data storage address record table of the loan file proof information register has the same proof information file storage data access code of the loan file storage data in the proof information file storage data access address of the loan file storage data;
wherein the loan data processing server F(P) accesses the loan file storage data stored in the proof information file storage data register based on the proof information file storage data access address of the loan file storage data in the proof information file storage data access address of the loan file storage data, and decrypts the loan file storage data using a user's personal encryption and decryption data sequence so as to obtain the loan file division record table;
wherein the loan file storage data is the loan application procedure file storage data, the loan investigation procedure file storage data, the loan appraisal procedure file storage data, the loan agreement procedure file storage data, the loan setting procedure file storage data, or the loan approval procedure file storage data;
wherein the loan data processing server F(P) accesses the loan file division file stored in the loan file division file register of the loan data processing server F(P) based on the loan file division record of the loan file division record table so that the loan file division file is configured to convert to the loan proof file using a conversion procedure, and the loan data processing server F(P) uses the conversion procedure to obtain the corresponding loan proof file based on the loan file division record of the loan file division record table;
wherein the loan data processing server F(P) sends the loan proof files to the intelligent loan procedure management server (C) based on the loan procedure serial number of the loan file storage data stored in the proof information file storage data index code of the loan file storage data, and stores the corresponding loan procedure data register having the same loan procedure serial number;
wherein the intelligent loan procedure management server (C) sends the loan proof files of the loan procedure data register and the loan proof records to the intelligent loan procedure platform server (W); and
wherein the intelligent loan procedure platform server (W) sends the loan proof files of the loan procedure and the loan proof records to the remote terminal (T) by performing the intelligent loan procedure of the finished data proof procedure which has been clicked by the user.
